(19) United States
(12) Patent Application Publication
(10) Pub. No.: US 2026/0320744 A1
(43) Pub. Date: Oct. 15, 2026

(54) INPUT INFORMATION GENERATING DEVICE, IMAGE PROCESSING DEVICE, INPUT INFORMATION GENERATING METHOD, LEARNING DEVICE, PROGRAM, AND LEARNING METHOD FOR NOISE REDUCTION DEVICE

(71) Applicant: Maxell, Ltd., Kyoto (JP)

(72) Inventors: Hiroshi NOJI, Tokyo (JP); Piyawat SUWANVITHAYA, Tokyo (JP)

(21) Appl. No.: 19/105,462

(22) PCT Filed: Jun. 7, 2023
(86) PCT No.: PCT/JP2023/021204

§ 371 Date: Aug. 28, 2025

(30) Foreign Application Priority Data
Aug. 31, 2022 (JP) 2022-137834
Aug. 31, 2022 (JP) 2022-137843

(51) Int. Cl. G06T 5/50; G06T 3/02; G06T 5/60; G06T 5/70; G06T 7/20

(52) U.S. Cl. CPC G06T 5/50; G06T 3/02; G06T 5/60; G06T 5/70; G06T 7/20; G06T 2207/10016; G06T 2207/10024; G06T 2207/20081; G06T 2207/20084; G06T 2207/20216; G06T 2207/30241

(57) ABSTRACT

An input information generation device includes an image acquiring unit configured to acquire a plurality of frames including at least a target frame of which input information is to be generated out of frames constituting a video as an input image, an input converting unit configured to convert pixel values of the acquired input image of the plurality of frames to input data with a smaller number of bits than the number of bits indicating the pixel values of the input image, a combination unit configured to combine the plurality of pieces of converted input data into one piece of combined data, and an output unit configured to output the combined data.

### CROSS-REFERENCE TO RELATED APPLICATIONS

This application is the U.S. National Stage entry of International Application No. PCT/JP2023/021204, filed on Jun. 7, 2023, which, in turn, claims priority to JP Patent Application No. 2022-137834, filed on Aug. 31, 2022, and JP Patent Application No. 2022-137843, filed on Aug. 31, 2022, all of which are hereby incorporated herein by reference in their entireties for all purposes.

### TECHNICAL FIELD

The present invention relates to an input information generation device, an image processing device, an input information generation method, a learning device, a program, and a learning method for a noise reduction device.

### BACKGROUND ART

At the time of capturing an image using an imaging device, when a quantity of ambient light is not sufficient or settings of the imaging device such as a shutter speed, an iris diaphragm, or an ISO sensitivity are not appropriate, a low-quality image may be obtained. There are known techniques of converting a captured low-quality image to a high-quality image through image processing. For example, there are techniques of image-processing a low-quality image to a high-quality image using machine learning (for example, see Patent Document 1). In this technical field, a first-priority requirement is to enhance the quality of an image.

### CITATION LIST

### Patent Document

Patent Document 1: U.S. Pat. No. 10,623,756.

### SUMMARY OF INVENTION

### Technical Problem

Here, it is conceivable that a low-quality video be converted to a high-quality video by applying the aforementioned related art to a video to enhance the image quality of frames constituting the video. When the image quality of a video captured by an imaging device is enhanced to high image quality in real time, there may be a problem in that a frame rate of the video will be sacrificed if it takes time to perform the image processing. That is, when a low-quality video is converted to a high-quality video, priority cannot be given to only enhancement in image quality of frame images, and the frame rate has to be maintained through image processing with a light computational load. The process of enhancing the image quality of a video may be performed by an edge device, and there is strong need for a decrease in computational load of image processing in consideration of processing capability of the edge device.

Therefore, an objective of the present invention is to provide a technique capable of converting a low-quality video to a high-quality video with a light computational load.

### Solution to Problem

(1) According to an aspect of the present invention, there is provided an input information generation device including: an image acquiring unit configured to acquire a plurality of frames including at least a target frame of which input information is to be generated out of frames constituting a video as an input image; an input converting unit configured to convert pixel values of the acquired input image of the plurality of frames to input data with a smaller number of bits than the number of bits indicating the pixel values of the input image; a combination unit configured to combine the plurality of pieces of converted input data into one piece of combined data; and an output unit configured to output the combined data.

(2) In the input information generation device according to (1), the video is a color video, the image acquiring unit acquires pixel values of colors as a plurality of different images from one frame, and the input converting unit converts the plurality of images acquired from one frame to the input data.

(3) In the input information generation device according to (1) or (2), the image acquiring unit acquires images of a plurality of frames which are continuously adjacent to before and after the target frame out of the frames constituting the video.

(4) In the input information generation device according to any one of (1) to (3), the image acquiring unit acquires a plurality of frames including at least the target frame with frames adjacent to the target frame as a target frame as the input image after the combined data for the target frame has been output by the output unit.

(5) The input information generation device according to any one of (1) to (4) further includes an integration unit configured to integrate a plurality of adjacent frames into one integrated frame by performing an arithmetic operation based on pixel values of the adjacent frames which are frames other than the target frame out of the plurality of frames acquired by the image acquiring unit, the input converting unit converts pixel values of the target frame to the input data and additionally converts pixel values of the integrated frame to the input data, and the combination unit combines the plurality of pieces of input data converted on the basis of the target frame and the plurality of pieces of input data converted on the basis of the integrated frame into one piece of combined data.

(6) In the input information generation device according to (5), the integration unit sets the average value of the pixel values of the plurality of adjacent frames as pixel values of the integrated frame.

(7) In the input information generation device according to (6), the integration unit calculates the pixel values of the integrated frame by calculating a weighted average based on the temporal distance from the target frame out of the plurality of adjacent frames.

(8) In the input information generation device according to (6), the integration unit excludes a frame with a large change in luminance out of the frames constituting the video from targets of which the average value is to be calculated.

(9) The input information generation device according to (5) further includes an average temporary storage unit configured to store an average value of pixel values of predetermined frames out of the frames constituting the video, and the integration unit calculates pixel values of the integrated frame through an arithmetic operation based on the value stored in the average temporary storage unit and the target frame.

(10) The input information generation device according to (9) further includes an imaging condition acquiring unit configured to acquire imaging conditions of the video and an adjustment unit configured to adjust the average value stored in the average temporary storage unit according to the acquired imaging conditions.

(11) The input information generation device according to (9) further includes a comparison unit configured to compare the pixel values of the target frame with the value stored in the average temporary storage unit, and the integration unit calculates the pixel values of the integrated frame by calculating a moving average based on the value stored in the average temporary storage unit and the target frame when a difference as a comparison result from the comparison unit is equal to or less than a predetermined value and sets the pixel values of the target frame as the pixel values of the integrated frame when the difference is not equal to or less than the predetermined value.

(12) In the input information generation device according to (5), the integration unit sets a frame which is randomly identified out of the adjacent frames acquired by the image acquiring unit as the integrated frame.

(13) According to another aspect of the present invention, there is provided an image processing device including the input information generation device according to any one of (1) to (12) and a convolutional neural network configured to receive the combined data output from the input information generation device as input information.

(14) According to another aspect of the present invention, there is provided an input information generation method including: an image acquiring step of acquiring a plurality of frames including at least a target frame of which input information is to be generated out of frames constituting a video as an input image; an input converting step of converting pixel values of the acquired input image of the plurality of frames to input data with a smaller number of bits than the number of bits indicating the pixel values of the input image; a combination step of combining the plurality of pieces of converted input data into one piece of combined data; and an output step of outputting the combined data.

(A1) According to another aspect of the present invention, there is provided a learning device including: an image acquiring unit configured to acquire first image information including at least one image and second image information having the same subject as a subject captured in the image included in the first image information captured therein and including at least one image with a lower image quality than that of the image included in the first image information; a video information generating unit configured to cut out a plurality of images at different positions which are a part of the acquired first image information, to combine the plurality of cut-out images to generate first video information, to cut out a plurality of images at different positions which are a part of the acquired second image information, and to combine the plurality of cut-out images to generate second video information; and a learning unit configured to perform learning to infer a high-quality video from a low-quality video on the basis of training data including the first video information and the second video information generated by the video information generating unit.

(A2) In the learning device according to (A1), the second image information includes a plurality of images in which the same subject as a subject captured in the image included in the first image information is captured and on which different values of noise are superimposed, and the video information generating unit generates the second video information by cutting out different parts from the plurality of images included in the second image information.

(A3) In the learning device according to (A1) or (A2), the plurality of images included in the second image information are images which are captured at proximately different times.

(A4) In the learning device according to any one of (A1) to (A3), the video information generating unit generates the first video information by cutting out different parts from the one image included in the first image information.

(A5) In the learning device according to any one of (A1) to (A4), the video information generating unit cuts out a plurality of images at different positions by shifting the plurality of cut-out images in a predetermined direction.

(A6) In the learning device according to any one of (A1) to (A5), the video information generating unit cuts out a plurality of images at positions which are shifted by a predetermined number of bits in a predetermined direction.

(A7) In the learning device according to (A6), the predetermined direction in which an image is cut out by the video information generating unit is calculated by an affine transformation.

(A8) The learning device according to (A6) further includes a trajectory vector acquiring unit configured to acquire a trajectory vector, and the predetermined direction in which an image is cut out by the video information generating unit is calculated on the basis of the acquired trajectory vector.

(A9) According to another aspect of the present invention, there is provided a learning device including: an image acquiring unit configured to acquire image information including at least one image; a cutout unit configured to cut out a plurality of images at different positions which are a part of the acquired image information; a first video information generating unit configured to combine the plurality of cut-out images to generate first video information; a noise superimposing unit configured to superimpose noise on the plurality of images cut out by the cutout unit; a second video information generating unit configured to combine the plurality of images on which noise is superimposed by the noise superimposing unit to generate second video information; and a learning unit configured to perform learning to infer a high-quality video from a low-quality video on the basis of training data including the first video information generated by the first video information generating unit and the second video information generated by the second video information generating unit.

(A10) According to another aspect of the present invention, there is provided a program causing a computer to perform: an image acquiring step of acquiring first image information including at least one image and second image information having the same subject as a subject captured in the image included in the first image information captured therein and including at least one image with a lower image quality than that of the image included in the first image information; a video information generating step of cutting out a plurality of images at different positions which are a part of the acquired first image information, combining the plurality of cut-out images to generate first video information, cutting out a plurality of images at different positions which are a part of the acquired second image information, and combining the plurality of cut-out images to generate second video information; and a learning step of performing learning to infer a high-quality video from a low-quality video on the basis of training data including the first video information and the second video information generated in the video information generating step.

(A11) According to another aspect of the present invention, there is provided a learning method for a noise reduction device, the learning method including: an image acquiring process of acquiring first image information including at least one image and second image information having the same subject as a subject captured in the image included in the first image information captured therein and including at least one image with a lower image quality than that of the image included in the first image information; a video information generating process of cutting out a plurality of images at different positions which are a part of the acquired first image information, combining the plurality of cut-out images to generate first video information, cutting out a plurality of images at different positions which are a part of the acquired second image information, and combining the plurality of cut-out images to generate second video information; and a learning process of performing learning to infer a high-quality video from a low-quality video on the basis of training data including the first video information and the second video information generated in the video information generating process.

### Advantageous Effects of Invention

According to the present invention, it is possible to convert a low-quality video to a high-quality video with a light computational load.

### BRIEF DESCRIPTION OF DRAWINGS

FIG. 1 A block diagram illustrating an example of a functional configuration of a high-quality video generation system according to a first embodiment.

FIG. 2 A diagram illustrating an example of a convolutional neural network according to the first embodiment.

FIG. 3 A diagram illustrating frames constituting a video according to the first embodiment.

FIG. 4 A diagram schematically illustrating an input information generation method according to the first embodiment.

FIG. 5 A block diagram illustrating an example of a functional configuration for input information generation according to the first embodiment.

FIG. 6 A block diagram illustrating an example of a functional configuration of an input converting unit according to the first embodiment.

FIG. 7 A diagram schematically illustrating an input information generation method according to a second embodiment.

FIG. 8 A block diagram illustrating an example of a functional configuration for input information generation according to the second embodiment.

FIG. 9 A block diagram illustrating an example of a functional configuration for input information generation according to a third embodiment.

FIG. 10 A block diagram illustrating an example of a functional configuration for input information generation according to a fourth embodiment.

FIG. 11 A diagram schematically illustrating a learning system according to a fifth embodiment.

FIG. 12 A diagram illustrating an example of a functional configuration of a learning device according to the fifth embodiment.

FIG. 13 A diagram illustrating an example of positions of images which are cut out from a high-quality image by the learning device according to the fifth embodiment.

FIG. 14 A diagram illustrating an example of positions of images which are cut out from a low-quality image by the learning device according to the fifth embodiment.

FIG. 15 A diagram illustrating an example of directions in which an image is cut out by the learning device according to the fifth embodiment.

FIG. 16 A diagram illustrating an example of a functional configuration of the learning device according to the fifth embodiment when the learning device generates a video on the basis of a trajectory vector.

FIG. 17 A diagram illustrating an example of positions of images which are cut out from a still image when a learning device according to a modified example of the fifth embodiment generates a video on the basis of a trajectory vector.

FIG. 18 A flowchart illustrating an example of an operation flow of a learning method for a noise reduction device according to a modified example of the fifth embodiment.

FIG. 19 A diagram schematically illustrating a learning system according to a sixth embodiment.

FIG. 20 A diagram illustrating an example of a functional configuration of a video information generating unit according to the sixth embodiment.

### DESCRIPTION OF EMBODIMENTS

Hereinafter, exemplary embodiments of an input information generation device, an image processing device, and an input information generation method according to an aspect of the present invention will be described in detail with reference to the accompanying drawings. Any aspect of the present invention is not limited to such embodiments and includes various modifications or improvements thereof. That is, elements described below include elements that can be easily thought out by those skilled in the art or elements that are substantially the same, and elements described below can be appropriately combined. Various omissions, substitutions, or modifications of elements can be carried out without departing from the gist of the present invention. In the drawings used for the following description, sizes, numbers, and the like of constituent members may be made to be different from actual sizes, numbers, and the like of the constituent members in order to make the constituent members be easily recognized.

First, the premises of the embodiments will be described below. In an input information generation device, an image processing device, and an input information generation method according to the present embodiments, high-quality video information with reduced noise is generated using low-quality video information with noise superimposed thereon as an input. The low-quality video includes a video with low image quality, and the high-quality video includes a video with high image quality. The high-quality video is, for example, a video with high image quality which is captured with low ISO sensitivity and long-second exposure. The low-quality video is, for example, a video with low image quality which is captured with high ISO sensitivity and short-second exposure.

In the following description, deterioration in image quality due to noise is mentioned as an example of a low-quality video, and these embodiments can be widely applied to factors causing quality deterioration of a video in addition to noise. Examples of the factors causing quality deterioration of a video include deterioration in resolution or color shift due to an optical aberration, deterioration in resolution due to camera shake or subject blurring, unevenness in black level due to a dark current or a circuit, a ghost or a flare due to a subject with high luminance, and signal level abnormality. Examples of noise include striped noise generated in a horizontal direction or a vertical direction of an image and noise generated as a fixed pattern in an image in addition to random noise generated for each pixel. The noise may include noise specific to a video such as flickered noise varying between successive frames. With the input information generation device, the image processing device, and the input information generation method according to these embodiments, it is possible to improve image quality of each frame and to enhance the quality of a video by performing image processing for each frame included in the video.

An input video to be enhanced in quality may be a video captured by an imaging device or may be a video which has been prepared in advance. In the following description, a low-quality video may be referred to as a video with low image quality or a noisy video. In the following description, a high-quality video may be referred to as a video with high image quality.

A video serving as a target of the input information generation device, the image processing device, and the input information generation method according to these embodiments may be a video which is captured by a charge-coupled device (CCD) camera employing a CCD image sensor. A video serving as a target of the input information generation device, the image processing device, and the input information generation method according to these embodiments may be an image which is captured by a complementary metal oxide semiconductor (CMOS) camera employing a CMOS image sensor. A video serving as a target of the input information generation device, the image processing device, and the input information generation method according to these embodiments may be a color video or may be a monochromatic video. A video serving as a target of the input information generation device, the image processing device, and the input information generation method according to these embodiments may be a video which is captured by a camera acquiring non-visible components such as an infrared camera using an infrared sensor.

### First Embodiment

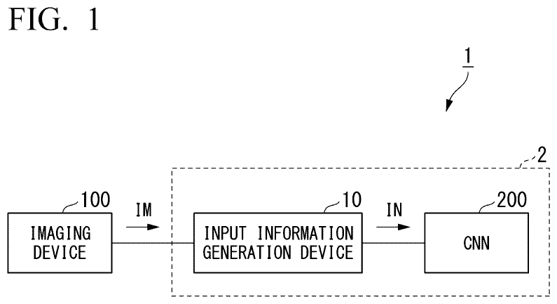

A first embodiment will be first described with reference to FIGS. 1 to 6.

FIG. 1 is a block diagram illustrating an example of a functional configuration of a high-quality video generation system according to the first embodiment. An example of the functional configuration of the high-quality video generation system 1 will be described below with reference to the drawing. The high-quality video generation system 1 includes an imaging device 100, an input information generation device 10, and a convolutional neural network 200 (hereinafter referred to as a “CNN 200”) as functions thereof. The input information generation device 10 and the CNN 200 perform image processing on each frame constituting a video captured by the imaging device 100. The input information generation device 10 and the CNN 200 include a learning model which has been trained in advance. In the following description, a configuration including the input information generation device 10 and the CNN 200 may be referred to as an image processing device 2. The high-quality video generation system 1 may have a configuration including an encoding unit for compressing and encoding an output of the image processing device 2 and a predetermined memory for storing results of compression and encoding from the encoding unit.

The imaging device 100 captures a video. The video captured by the imaging device 100 is a low-quality video to be enhanced in quality. The imaging device 100 may be, for example, a monitoring camera which is installed in a dark place (with a small quantity of light). The imaging device 100 captures, for example, a low-quality video due to shortage of a quantity of light. The imaging device 100 outputs the captured video to the input information generation device 10. The video captured by the imaging device 100 is input to the image processing device 2. Accordingly, the video output from the imaging device 100 to the input information generation device 10 may be referred to as video information IM.

The imaging device 100 and the image processing device 2 may be provided in a housing of a smartphone, a tablet terminal, or the like. That is, the high-quality video generation system 1 may be provided as an element of an edge device. The imaging device 100 may be connected to the image processing device 2 via a predetermined communication network. That is, the high-quality video generation system 1 may be provided by connecting constituents via a predetermined communication network.

The imaging device 100 may have a configuration including a plurality of lenses and a plurality of image sensors corresponding to the plurality of lenses. A specific example of this configuration is a configuration in which the imaging device 100 includes a plurality of lenses and a plurality of image sensors to acquire images at different angles of view. With the imaging device 100 having this configuration, images acquired from the image sensors can be said to be spatially adjacent to each other. The high-quality video generation system 1 can be applied to a plurality of images spatially adjacent to each other in addition to a plurality of images temporally adjacent to each other such as a video.

The input information generation device 10 acquires video information IM from the imaging device 100. The input information generation device 10 generates input information IN on the basis of the acquired video information IM. The input information IN is generated for each frame of the video information IM. The input information IN may be generated on the basis of a target frame and other frames determined on the basis of the target frame. The other frames determined on the basis of the target frame may be frames which are temporally adjacent to the target frame.

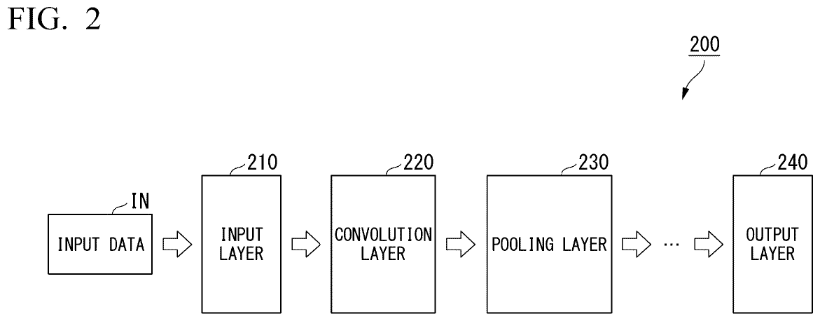

The CNN 200 is a convolutional neural network with data output from the input information generation device 10 as input information IN. An example of the CNN 200 will be described below with reference to FIG. 2.

FIG. 2 is a diagram illustrating an example of the CNN 200 according to the first embodiment. Details of the CNN 200 will be described below in detail with reference to the drawing. The CNN 200 is a neural network having a multi-layered structure. The CNN 200 is a network with a multi-layered structure including an input layer 210 to which input information IN is input, a convolution layer 220 which performs a convolutional operation, a pooling layer 230 which performs pooling, and an output layer 240. In at least a part of the CNN 200, the convolution layer 220 and the pooling layer 230 are alternately connected. The CNN 200 is a model which is widely used for image recognition or video recognition. The CNN 200 may further include a layer having another function such as a total coupling layer. The pooling layer 230 may include a quantization layer for performing a quantization operation for decreasing the operation result from the convolution layer 220 to a lower number of bits. Specifically, the quantization layer performs an arithmetic operation of reducing the number of bits of the result of the convolutional operation in the quantitation layer to 8 bits or less when the result of the convolutional operation in the convolution layer 220 is 16 bits.

The CNN 200 may employ a configuration in which outputs of a plurality of convolution layers 220 and a plurality of pooling layers 230 included in the CNN 200 are input as an intermediate output to another layer. In another embodiment, the CNN 200 may constitute a U-net by inputting outputs of a plurality of convolution layers 220 and a plurality of pooling layers 230 included in the CNN 200 as an intermediate output to another layer. In this case, the CNN 200 includes an encoder unit that extracts features through a convolutional operation and a decoder unit that performs a deconvolutional operation on the basis of the extracted features.

Input information IN is input to the input layer 210. The input information IN is generated on the basis of an input image. The input image is a frame image constituting a video. The input information generation device 10 according to the present embodiment generates input information IN from an input image. In the present embodiment, elements of the input information IN may be, for example, integers of 2 bits with no sign (0, 1, 2, 3). Elements of input data may be, for example, integers of 4 bits or 8 bits.

The convolution layer 220 performs a convolutional operation on the input information IN input to the input layer 210. The convolution layer 220 performs the convolutional operation on the input information IN of low bits. The convolution layer 220 outputs predetermined output data to the pooling layer 230 as a result of a predetermined convolutional operation.

The pooling layer extracts a representative value of a certain area on the basis of the result of the convolutional operation from the convolution layer 220. Specifically, the pooling layer 230 performs an arithmetic operation such as average pooling or MAX pooling on the output data of the convolutional operation output from the convolution layer 220 and compresses the output data of the convolution layer 220.

The output layer 240 is a layer that outputs the result of the CNN 200. The output layer 240 may output the result of the CNN 200, for example, using an identity function or a Softmax function. A layer provided in the stage before the output layer 240 may be the convolution layer 220, the pooling layer 230, or another layer.

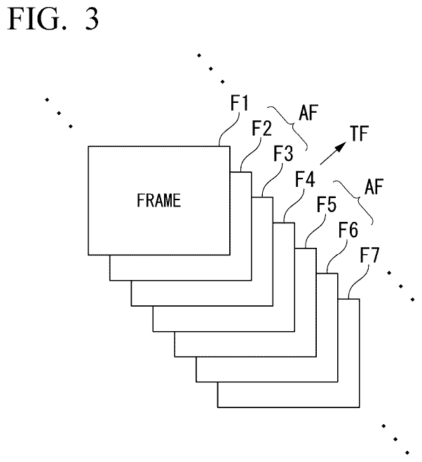

FIG. 3 is a diagram illustrating frames constituting a video according to the first embodiment. Frames which are used for the input information generation device 10 to generate input information IN will be described below with reference to the drawing. In the drawing, a plurality of successive frames constituting a video are illustrated. Frames F1 to F7 illustrated in the drawing are an example of the plurality of successive frames constituting a video.

Each frame is an RAW image which has not been compressed and encoded, and each pixel is expressed by 12 bits or 14 bits. Each frame includes a number of pixels required for satisfying a predetermined video format such as 1920×1080 or 4096×2160. In the present embodiment, a processing target in the CNN 200 is described as an RAW image, but is not limited thereto. When an image to be processed sufficiently includes signal components, an image on which processing such as compression and encoding has been performed may be used as a processing target.

The input information generation device 10 generates input information IN on the basis of a target frame TF which is a frame to be processed and adjacent frames AF which are frames adjacent to the target frame TF. The adjacent frames AF are, for example, frames which are successively adjacent to before or after the target frame TF. In the illustrated example, two frames adjacent to before and after the target frame TF are used as the adjacent frames AF. That is, when the target frame TF is set to frame F4, frame F2, frame F3, frame F5, and frame F6 are the adjacent frames AF.

The number of adjacent frames AF is not limited to this example, and may be one frame or three frames before and after the target frame TF. The adjacent frames AF are not limited to the example in which they are adjacent to both before and after the target frame TF and may include, for example, only frames adjacent to one of before and after the target frame TF. The adjacent frames AF do not have to be successive to the target frame TF and may include frame F2 and frame F6 which are not successive to frame F4 when the target frame TF is frame F4.

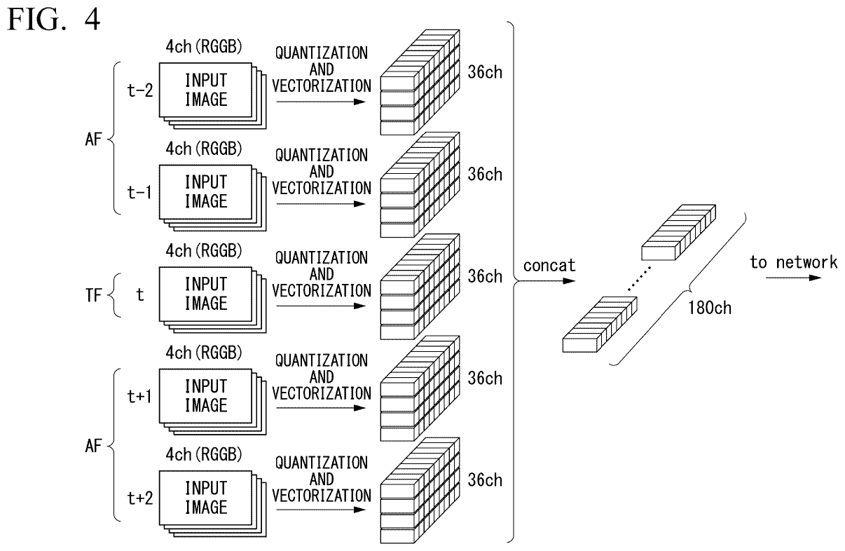

FIG. 4 is a diagram schematically illustrating an input information generation method according to the first embodiment. A method of generating input information IN in the input information generation device 10 will be described below with reference to the drawing. In the drawing, a frame at time t−2, a frame at time t−1, a frame at time t, a frame at time t+1, and a frame at time t+2 are illustrated. The frame at time t corresponds to the target frame TF, and the frames at time t−2, time t−1, time t+1, and time t+2 correspond to the adjacent frames AF. Since each frame includes a plurality of pixels, a circuit that simultaneously processes all the pixels has a large scale. Accordingly, when the CNN 200 performs the processing, it is preferable that each frame be divided into a predetermined size. In the present embodiment, for example, the pixels are divided with a size of 256×256 as one patch.

Each frame includes image data of four channels including a red (R) channel, two green (G) channels, and a blue (B) channel. The input information generation device 10 performs quantization and vectorization of each channel. For example, the input information generation device 10 generates vectorized data of 9 channels from the image data of each channel. That is, the input information generation device 10 generates data of 4 channels×9 channels=36 channels from one frame. Data of 9 channels may be data in which pixel values are quantized using different threshold values. The input information generation device 10 combine (concat) data of 5 frames×36 channels=180 channels generated from the target frame TF and the adjacent frames AF (a total of 5 frames in the illustrated example). The input information generation device 10 outputs the combined data of 180 channels as input information IN to the input layer of the CNN 200.

In the illustrated example, input information IN is generated using image data of 4 channels constituting one frame, but an aspect of the present embodiment is not limited to this example. The input information generation device 10 may generate input information IN, for example, on the basis of data of 3 channels including RGB. In the illustrated example, data of 9 channels is generated by performing quantization and vectorization on the basis of image data, but an aspect of the present embodiment is not limited to this example. The number of pieces of data generated is preferably a number with which an efficient arithmetic operation is possible after being combined. The input information generation device 10 may generate data of N channels×M channels by generating data of M channels (where M is a natural number equal to or greater than 1) for each piece of image data of N channels (where N is a natural number equal to or greater than 1) constituting one frame. The value of N×M is preferably a value close to a multiple of 32 (or 64).

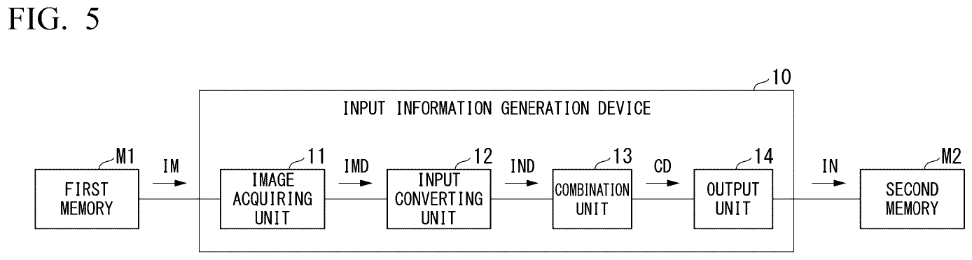

FIG. 5 is a block diagram illustrating an example of the functional configuration of input information generation according to the first embodiment. An example of the functional configuration of the input information generation device 10 will be described below with reference to the drawing. The input information generation device 10 includes an image acquiring unit 11, an input converting unit 12, a combination unit 13, and an output unit 14. The input information generation device 10 includes a central processing unit (CPU) and a storage device such as a read only memory (ROM) or a random-access memory (RAM) which are not illustrated and which are connected via a bus. The input information generation device 10 serves as a device including the image acquiring unit 11, the input converting unit 12, the combination unit 13, and the output unit 14 by executing an input information generation program.

All or some of the functions of the input information generation device 10 may be realized by hardware such as an application-specific integrated circuit (ASIC), a programmable logic device (PLD), or a field-programmable gate array (FPGA). The input information generation program may be recorded on a computer-readable recording medium. The computer-readable recording medium is, for example, a portable medium such as a flexible disk, a magneto-optical disk, a ROM, or a CD-ROM or a storage device such as a hard disk incorporated into a computer system. The input information generation program may be transmitted via an electrical communication line.

In the illustrated example, a memory in which video information IM of a video captured by the imaging device 100 is stored is referred to as a first memory M1, and a memory in which input information IN generated by the input information generation device 10 is stored is referred to as a second memory M2. The first memory M1 and the second memory M2 are storage devices such as a ROM or a RAM.

The image acquiring unit 11 acquires image information IMD including an input image used for processing out of the video information IM stored in the first memory M1. Specifically, the image acquiring unit 11 acquires a plurality of frames including at least a target frame TF of which input information IN is to be generated out of a plurality of frames constituting a video as an input image. For example, the image acquiring unit 11 acquires an adjacent frame AF in addition to the target frame TF as an input image. The adjacent frame AF may be a plurality of frames which are successively adjacent to before and after the target frame TF.

When a video captured by the imaging device 100 is a color video, the image acquiring unit 11 acquires pixel values of colors as a plurality of different images from one frame. For example, when the imaging device 100 uses an image sensor employing a Bayer array, the image acquiring unit 11 acquires image information of 4 channels of RGGB from one frame. Pixel values of the images acquired by the image acquiring unit 11 include elements of multiple bits.

The input converting unit 12 acquires image information IMD from the image acquiring unit 11. The input converting unit 12 converts pixel values of the input images of a plurality of frames included in the image information IMD to input data IND of less bits on the basis of comparison with a plurality of threshold values. Since the input images are RAW images and pixel values thereof include elements of multiple bits (for example, 12 bits or 14 bits), the image acquiring unit 11 converts the pixel values of the input images to input data IND of the number of bits (for example, 2 bits or 1 bit) equal to or less than the number of bits (for example, 8 bits) indicating the pixel values of the input images on the basis of a plurality of threshold values. The input converting unit 12 outputs the converted input data IND to the combination unit 13.

When the image information IMD includes image information of RGB colors, the input converting unit 12 performs conversion for each color. That is, the input converting unit 12 converts each of the plurality of images acquired from one frame to input data IND.

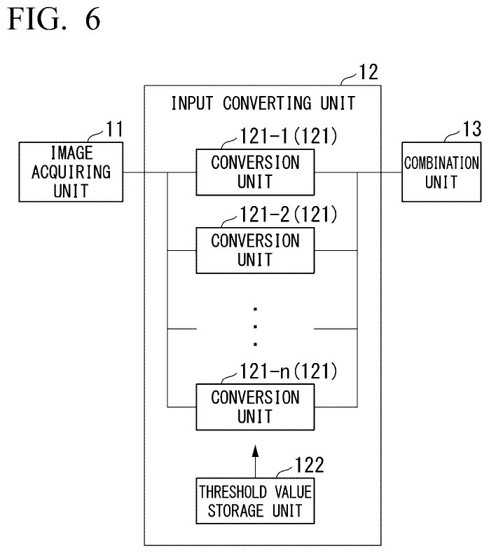

FIG. 6 is a block diagram illustrating an example of a functional configuration of the input converting unit according to the first embodiment. Details of the function of the input converting unit 12 will be described below with reference to the drawing. As illustrated in the drawing, the input converting unit 12 includes a plurality of conversion units 121 and a threshold value storage unit 122. In the illustrated example, the input converting unit 12 includes a conversion unit 121-1, a conversion unit 121-2, . . . , a conversion unit 121-n (where n is a natural number equal to or greater than 1) as an example of the plurality of conversion units 121. The number of conversion units 121 included in the input converting unit 12 may be the number of pieces of input data IND which is generated from the input images of one channel by the input converting unit 12. That is, when the input converting unit 12 converts an input image of 1 channel to input data IND of 9 channels, the input converting unit 12 includes 9 conversion units 121 including the conversion units 121-1 to 121-9.

In the illustrated example, it is assumed that image data of an input image has a data structure of a matrix including multiple values of a larger number of bits than 8 bits as elements in an x-axis direction and a y-axis direction as pixel data. When this image data of an input image is converted by the input converting unit 12, the elements are quantized into input data of less bits (for example, 2 bits or one bit equal to or less than 8 bits).

The conversion units 121 compare elements of the input image with a predetermined threshold value. The conversion units 121 quantize the elements of the input image on the basis of the result of comparison. For example, the conversion units 121 quantize the input image of 12 bits to values of 2 bits or 1 bit. The conversion units 121 may perform quantization through comparison with threshold values corresponding to the number of bits after conversion. For example, one threshold value can be used for conversion to 1 bit, and three threshold values may be used for conversion to 2 bits. In other words, one threshold value may be used when quantization performed by the conversion units 121 is 1-bit quantization, and three threshold values may be used when the quantization is 2-bit quantization. When a plurality of threshold values are required like 8 bits, quantization may be performed using a function, a table, or the like instead of threshold values.

The conversion units 121 perform quantization using independent threshold values for the same elements. That is, the input converting unit 12 outputs a vector including elements corresponding to the number of conversion units 121 as an operation result (input data IND) in response to an input of one channel. Bit precision of the conversion result which is the output of the conversion units 121 may be appropriately changed on the basis of bit precision of an input image or the like.

The threshold value storage unit 122 stores a plurality of threshold values which are used for the operations performed by the conversion units 121. The threshold values stored in the threshold value storage unit 122 are predetermined values and are set to correspond to the plurality of conversion units 121. Each threshold value may be a parameter to be learned and may be determined and updated in a learning step.

In the illustrated example, the same elements of the input image are input to the plurality of conversion units 121, but the aspect of the input converting unit 12 is not limited thereto. For example, when an input image is image data including elements of 3 channels including color components, the conversion units 121 may be divided into a plurality of groups, and corresponding elements may be input and converted by the groups. An element input to a predetermined conversion unit 121 other than the color components may be subjected to a certain conversion process in advance, or to what conversion unit 12 an element is to be input may be switched depending on whether pre-processing has been performed. All the elements of the input image may not be subjected to a conversion process, or a conversion process may be performed, for example, on only an element corresponding to a specific color which is a specific element in the input image.

The number of conversion units 121 may not be fixed and may be appropriately determined according to a structure or hardware information of a neural network. When a decrease in operation precision in quantization performed by the conversion units 121 needs to be complemented, the number of conversion units 121 can be preferably set to be equal to or greater than bit precision of elements of the input image. In more general, it is preferable that the number of conversion units 121 be set to be equal to or greater than a difference in bit precision of an input image between before and after quantization. Specifically, when an input image in which each pixel value is expressed by 8 bits is quantized to 1 bit, the number of conversion units 121 can be preferably set to equal to or greater than 7 (for example, 16 or 32) corresponding to 7 bits which is a difference therebetween.

Referring back to FIG. 5, the combination unit 13 combines (concat) a plurality of pieces of converted input data IND into one piece of data. Data into which a plurality of pieces of input data are combined is also referred to as combined data CD. A combination process performed by the combination unit 13 may be a process of arranging (or connecting) a plurality of pieces of input data IND in one piece of data.

The output unit 14 outputs the combined data CD combined by the combination unit 13. The combined data CD may be temporarily stored in the second memory M2. That is, the combined data CD is input information IN input to the input layer 210 of the CNN 200.

After having generated input information IN for a target frame TF, the input information generation device 10 generates the input information IN for a next frame of the target frame TF. The next frame may be a frame temporally subsequent to the target frame TF. That is, after the combined data CD for the target frame TF has been output from the output unit 14, the image acquiring unit 11 shifts the target frame TF by one frame and acquires a frame adjacent to the target frame TF as a target frame TF. In this way, the input information generation device 10 acquires a plurality of frames including at least the target frame TF as an input image and generates the combined data CD.

The input information generation device 10 generates input information IN for all the frames included in the video information IM. In the aforementioned example, the input information generation device 10 generates the input information IN for all the frames included in the video information IM, but the aspect of the present embodiment is not limited to this example. For example, the input information generation device 10 may generate the input information IN every predetermined frames. The high-quality video generation system 1 converts a low-quality video to a high-quality video on the basis of the video information IM, and an output format is not limited to the format of a video. For example, the high-quality video generation system 1 may generate a still image from a video. That is, by setting a frame extracted from a video as a target frame TF, the present embodiment can also be applied to a case in which the high-quality video generation system 1 extracts a frame included in the video information IM and generates a still image.

### Summary of First Embodiment

According to the aforementioned embodiment, the input information generation device 10 includes the image acquiring unit 11 to acquire a plurality of frames including at least a target frame TF of which input information IND is to be generated out of frames constituting a video as input images. The input information generation device 10 includes the input converting unit 12 to convert pixel values of the acquired input images of the plurality of frames to input data IND of the smaller number of bits (for example, 2 bits or 1 bit which is equal to or less than 8 bits) than the number of bits (for example, 12 bits) indicating the pixel values of the input images on the basis of comparison with a plurality of threshold values. The input information generation device 10 includes the combination unit 13 to combine the plurality of pieces of converted input data IND into one piece of combined data CD and includes the output unit 14 to output the combined data CD. That is, according to the present embodiment, the input information generation device 10 combines a plurality of pieces of input data IND acquired from a plurality of images including at least the target frame TF and generates input information IN. The generated input information IN is input to the input layer 210 of the CNN 200.

Here, the input information IN is information of a smaller number of bits than the input image for each element. The CNN 200 can process information of a smaller number of bits by processing the input information IN instead of the input images. Accordingly, according to the present embodiment, it is possible to decrease a process load of the CNN 200. The input information IN is information which is generated on the basis of a plurality of images. Accordingly, when the quality of a video is increased on the basis of the input information IN, a process in consideration of a plurality of frames adjacent to the target frame TF can be performed, and thus it is possible to remove noise with high accuracy. As a result, according to the present embodiment, it is possible to convert a low-quality video to a high-quality video with a low computational load. The process of the CNN 200 is not limited to noise removal.

According to the aforementioned embodiment, since a video to be processed is a color video, the video information IM includes, for example, pixel values of RGB colors. The image acquiring unit 11 acquires pixel values of the colors from one frame as a plurality of different images, and the input converting unit 12 converts the plurality of images acquired from one frame to different pieces of input data IND. Accordingly, according to the present embodiment, it is possible to perform image processing with higher precision. As a result, according to the present embodiment, it is possible to remove noise with higher accuracy.

According to the aforementioned embodiment, the image acquiring unit 11 acquires images of a plurality of frames successively adjacent to before and after the target frame TF out of a plurality of frames constituting a video. According to the present embodiment, since the input information IN is generated on the basis of information on the frames adjacent to before and after the target frame TF, it is possible to perform image processing with higher precision. Accordingly, according to the present embodiment, it is possible to remove noise with higher accuracy.

According to the aforementioned embodiment, the image acquiring unit 11 sets a frame adjacent to the target frame TF as a target frame TF and acquires a plurality of frames including at least the target frame TF as the input images after the combined data CD for the target frame TF has been output by the output unit 14. That is, the input information generation device 10 generates input information IN for each of the plurality of frames included in the video while sequentially shifting the target frame TF. Accordingly, according to the present embodiment, it is possible to convert a low-quality video to a high-quality video.

### Second Embodiment

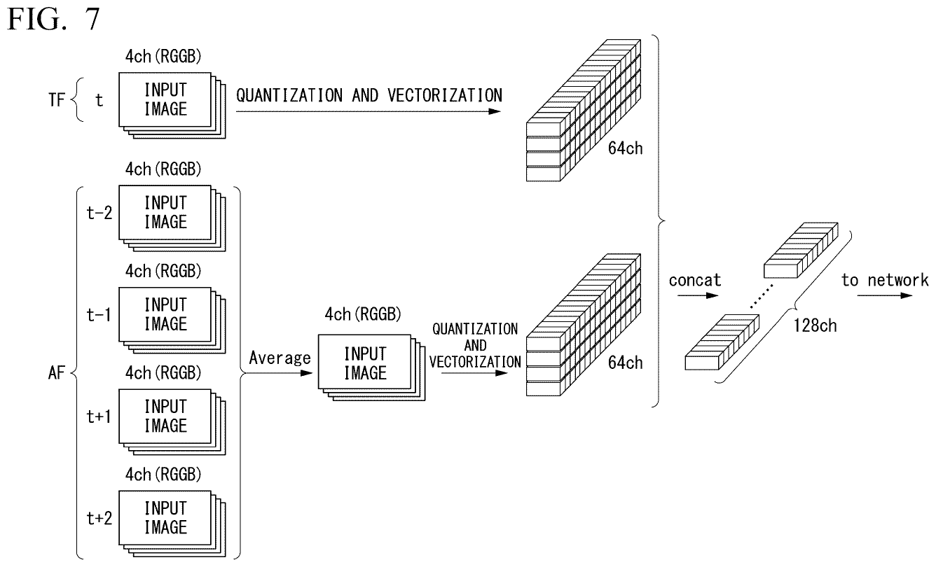

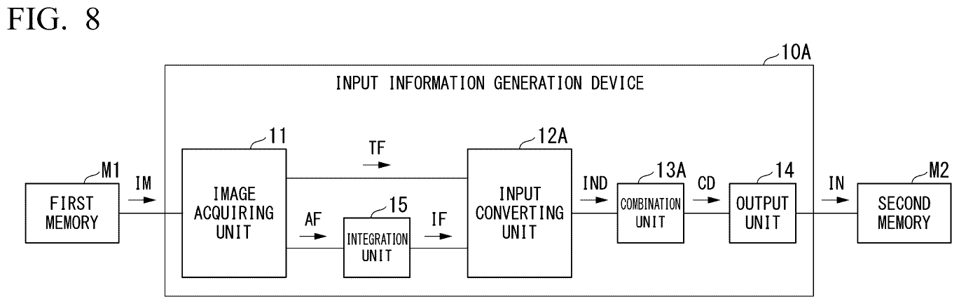

A second embodiment will be described below with reference to FIGS. 7 and 8. Problems to be solved by the second embodiment will be first described. The input information generation device 10 according to the first embodiment reads a plurality of frames including a target frame TF and adjacent frames AF and performs quantization for each of the plurality of frames. Accordingly, with the input information generation device 10 according to the first embodiment, the number of frames to be quantized is large, and a computational load of a first layer increases. The second embodiment is for solving this problem to further decrease the computational load.

FIG. 7 is a diagram schematically illustrating an input information generation method according to the second embodiment. A method of generating input information IN which is performed by an input information generation device 10A according to the second embodiment will be described below with reference to the drawing. In the drawing, a frame at time t is illustrated as a target frame TF. In the drawing, a frame at time t−2, a frame at time t−1, a frame at time t+1, and a frame at time t+2 are illustrated as adjacent frames AF.

Each frame includes image data of 4 channels of RGGB. The input information generation device 10A performs quantization and vectorization of each channel on the target frame TF. The input information generation device 10A performs quantization and vectorization of each channel on an average image of the adjacent frames AF. That is, the second embodiment is different from the first embodiment, in that quantization and vectorization are performed on an average image of adjacent frames AF instead of performing quantization and vectorization on each of the adjacent frames AF.

In the illustrated example, each piece of image data of 4 channels of RGGB is converted to data of 16 channels. Accordingly, data of 4 channels×16 channels=64 channels is generated from one frame. The input information generation device 10A converts each of a target frame TF and an average image of the adjacent frames AF to data of 64 channels, and thus data of a total of 128 channels is generated.

An averaging process may be performed by calculating a simple average of pixel values. The input information generation device 10A may generate an average image for each color by calculating an average for each color. That is, the input information generation device 10A may generate an average image based on R images of the adjacent frames AF at times t−-2 to t+2, generate an average image based on G images of the adjacent frames AF at times t−2 to t+2, and generate an average image based on B images of the adjacent frames AF at times t−2 to t+2.

In the illustrated example, quantization and vectorization are performed after the averages of the adjacent frames AF have been calculated, but an aspect of the present embodiment is not limited to this example. The input information generation device 10A may be configured, for example, to calculate an average after having performed quantization and vectorization.

After quantization and vectorization of the target frame TF have been performed and quantization and vectorization of the average image of the adjacent frames AF have been performed, input information IN is generated by combining the results of quantization and vectorization. In the illustrated example, data of 128 channels is generated. The combined input information IN has a smaller amount of information than that in the first embodiment. On the other hand, data expressing the target frame TF has a larger amount of information than that in the first embodiment.

FIG. 8 is a block diagram illustrating an example of a functional configuration for input information generation according to the second embodiment. An example of the functional configuration of the input information generation device 10A will be described below with reference to this drawing. The input information generation device 10A is different from the input information generation device 10 in that an integration unit 15 is further provided and an input converting unit 12A is provided instead of the input converting unit 12 and a combination unit 13A is provided instead of the combination unit 13. In description of the input information generation device 10A, the same elements as in the input information generation device 10 will be referred to by the same reference signs, and thus description thereof may be omitted.

The integration unit 15 acquires information on an adjacent frame AF from the image acquiring unit 11. An adjacent frame AF is a frame other than the target frame TF out of a plurality of frames acquired by the image acquiring unit 11. The integration unit 15 performs a process of integrating a plurality of adjacent frames AF into one integrated frame IF by performing an arithmetic operation based on pixel values of the adjacent frames AF. The integration unit 15 outputs the integrated frame IF acquired as a result of the arithmetic operation to the input converting unit 12A.

The integration unit 15 may perform an integration process, for example, by calculating a simple average of the adjacent frames AF. In this case, for example, the integration unit 15 uses average values of pixel values of a plurality of adjacent frames AF as pixel values of the integrated frame IF.

An aspect of the integration process performed by the integration unit 15 according to the present embodiment is not limited to an example in which the simple average is calculated. For example, the integration unit 15 may perform the integration process by calculating a weighted average. The weighted average is calculated according to the temporal distance from the target frame TF. For example, the integration unit 15 may decrease a weight by multiplying 0.7 less than 1 by pixel values of the frames at times t−2 and t+2 which are temporally farther from time t and increase the weight by multiplying 1.3 which is greater than 1 by pixel values of the frames at times t−1 and t+1 which are temporally closer to time t. That is, the integration unit 15 may calculate the pixel values of the integrated frame IF by calculating the weighted average of the plurality of adjacent frames AF based on the temporal distance from the target frame TF. By performing integration using the weighted average, a degree of contribution of the target frame TF with respect to the adjacent frames AF can be reflected in the integrated frame IF. The magnitude of the multiplied weight may vary according to before or after the target frame TF even if the temporal distance from the target frame TF is the same. For example, the weight may be set to be larger when the adjacent frame AF is before the target frame TF, and the weight may be set to be smaller when the adjacent frame AF is after the target frame TF.

The input converting unit 12A converts the pixel values of the target frame TF acquired from the image acquiring unit 11 to input data IND on the basis of comparison with a plurality of threshold values. The input converting unit 12A converts the pixel values of the integrated frame IF acquired from the integration unit 15 to input data on the basis of comparison with a plurality of threshold values. The input converting unit 12A outputs the converted input data IND to the combination unit 13A.

The combination unit 13A combines a plurality of pieces of input data IND converted on the basis of the target frame TF and a plurality of pieces of input data IND converted on the basis of the integrated frame IF into one piece of combined data CD.

The combined input information IN has a smaller amount of information than that in the first embodiment.

### Summary of Second Embodiment

According to the aforementioned embodiment, the input information generation device 10A further includes the integration unit 15 to perform an arithmetic operation based on the pixel values of the adjacent frames AF and to integrate the plurality of adjacent frames AF into one integrated frame IF. The input converting unit 12A converts the pixel values of the target frame TF to input data IND on the basis of comparison with a plurality of threshold values and additionally converts the pixel values of the integrated frame IF to input data IND on the basis of comparison with a plurality of threshold values. The combination unit 13A combines a plurality of pieces of input data IND converted on the basis of the target frame TF and a plurality of pieces of input data IND converted on the basis of the integrated frame IF into one piece of combined data CD. That is, instead of performing quantization and vectorization of the adjacent frames AF similarly to the target frame TF, the input information generation device 10A calculates an integrated frame IF based on a plurality of adjacent frames AF and performs quantization and vectorization of the integrated frame IF. Accordingly, the input information IN combined by the combination unit 13A has a smaller amount of information than that in the first embodiment, and it is possible to decrease the computational load of a first layer.

According to the aforementioned embodiment, the integration unit 15 sets average values of the pixel values of the plurality of adjacent frames AF as pixel values of the integrated frame IF. That is, the integration unit 15 uses simple averages of the adjacent frames AF as the integrated frame IF. Accordingly, according to the present embodiment, it is possible to generate input information IN which has a smaller amount of information than that of the input information IN according to the first embodiment through easier arithmetic operation and to decrease the computational load of the first layer.

According to the aforementioned embodiment, the integration unit 15 calculates the pixel values of the integrated frame IF by calculating the weighted average of the plurality of adjacent frames AF based on the temporal distance from the target frame TF. Accordingly, according to the present embodiment, it is possible to generate an integrated frame IF in consideration of a degree of contribution of the adjacent frames AF with respect to the target frame TF. As a result, the CNN 200 can more precisely perform image processing using the input information IN generated by the input information generation device 10A.

### Third Embodiment

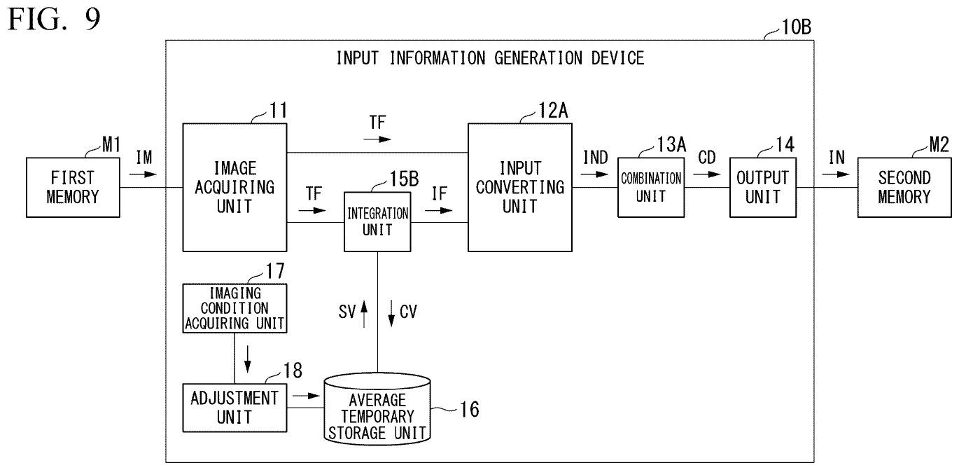

A third embodiment will be described below with reference to FIG. 9. Problems to be solved by the third embodiment will be first described. The input information generation device 10A according to the second embodiment includes the integration unit 15 to calculate the average values of the adjacent frames AF. When the target frame TF is shifted by one frame, it is not efficient to calculate average values of each frame because repetition of processes is generated. The third embodiment is for solving this problem to further decrease the computational load.

FIG. 9 is a block diagram illustrating an example of a functional configuration for input information generation according to the third embodiment. An example of the functional configuration of an input information generation device 10B will be described below with reference to this drawing. The input information generation device 10B is different from the input information generation device 10A, in that an average temporary storage unit 16, an imaging condition acquiring unit 17, and an adjustment unit 18 are additionally provided and an integration unit 15B is provided instead of the integration unit 15. In description of the input information generation device 10B, the same elements as in the input information generation device 10A will be referred to by the same reference signs, and thus a description thereof may be omitted.

The average temporary storage unit 16 stores average values of pixel values of predetermined frames out of frames constituting a video. Values stored in the average temporary storage unit 16 are calculated by the integration unit 15B. The integration unit 15B acquires information on a target frame TF from the image acquiring unit 11 and acquires stored values SV from the average temporary storage unit 16. The integration unit 15B calculates pixel values of an integrated frame IF through an arithmetic operation based on the target frame TF and the stored values SV stored in the average temporary storage unit 16. The integration unit 15B stores the calculated values as calculated values CV in the average temporary storage unit 16. That is, the values stored in the average temporary storage unit 16 may be updated whenever the integration unit 15B performs an arithmetic operation of a new target frame TF. By repeating this arithmetic operation, the input information generation device 10B calculates a moving average on the basis of the target frame TF. Regarding an arithmetic operation on a first frame, since stored values SV are not yet stored in the average temporary storage unit 16, the integration unit 15B may perform the arithmetic operation on the basis of only the target frame TF.

The imaging condition acquiring unit 17 acquires imaging conditions of a video from the imaging device 100. The imaging conditions of a video acquired by the imaging condition acquiring unit 17 may be, for example, settings of the imaging device such as a shutter speed, an aperture, and ISO sensitivity. The imaging conditions of a video acquired by the imaging condition acquiring unit 17 may include other information on operating or driving of the imaging device 100.

The adjustment unit 18 adjusts values (average values) stored in the average temporary storage unit 16 according to the imaging conditions acquired by the imaging condition acquiring unit 17. Here, when the imaging conditions of the imaging device 100 are changed, a relationship between the pixel values of the target frame TF and past moving average values is changed. For example, when the ISO sensitivity is changed to two times through changing of the settings of the imaging device 100, the pixel values of the target frame TF become higher than the past moving average values, and thus the moving average values becomes darker suddenly. Accordingly, when the ISO sensitivity is changed to two times through changing of the settings of the imaging device 100, the integration unit 15B can continue to calculate the moving average values using the values stored in the average temporary storage unit 16 by doubling the values stored in the average temporary storage unit 16.

When a scene of which a video is captured is switched and moving averages are calculated along with past frames, image processing on the target frame TF may not be appropriately performed by the CNN 200. Accordingly, when a scene of which a video is captured is switched, it is preferable not to calculate the moving average along with the past frames. The adjustment unit 18 may be configured to start newly calculating the moving average values using the integration unit 15B by resetting the values stored in the average temporary storage unit 16 when a scene of which a video is captured is switched. Whether a scene of which a video is captured is switched may be determined on the basis of ON/OFF of a power supply button of the imaging device 100, ON/OFF of an imaging button or a stop button, or the like.

A frame with a large change in luminance may be inserted in a plurality of frames included in a video. Examples of a case in which a frame with a large change in luminance is inserted include a case in which a light source is imaged with change of an imaging angle or the like and a case in which a headlight of a vehicle is captured. In this case, the integration unit 15B may exclude the frame with a large change in luminance out of the plurality of frames from targets of which the average value is to be calculated. By excluding the frame with a large change in luminance from targets of which the average value is to be calculated, it is possible to prevent a moving average value from being affected by the frame with a large change in luminance. In an example in which it is determined whether a change in luminance is large, pixel values of a target frame TF to be calculated may be compared with pixel values of a previous target frame TF, and it may be determined whether a difference therebetween is equal to or less than a threshold value.

### Summary of Third Embodiment

According to the aforementioned embodiment, the input information generation device 10B further includes the average temporary storage unit 16 to store the average value of pixel values in predetermined frames out of frames constituting a video. In the input information generation device 10B, the integration unit 15B calculates pixel values of an integrated frame IF through an arithmetic operation based on values stored in the average temporary storage unit 16 and the target frame TF. That is, the input information generation device 10B calculates the pixel values of the integrated frame IF on the basis of the target frame TF and the stored moving average values. Accordingly, the input information generation device 10B has a lighter computational load than the input information generation device 10A. As a result, according to the present embodiment, it is possible to further decrease the computational load.

According to the aforementioned embodiment, the integration unit 15B excludes a frame with a large change in luminance out of a plurality of frames constituting a video from targets of which the average value is to be calculated. Accordingly, according to the present embodiment, when a change in luminance increases suddenly, it is possible to prevent the pixel values of the integrated frame IF from being affected by pixel values of the frame with a suddenly increased change in luminance by excluding the corresponding frame from calculation of the moving average value.

According to the aforementioned embodiment, the input information generation device 10B further includes the imaging condition acquiring unit 17 to acquire imaging conditions of a video and further includes the adjustment unit 18 to adjust the average values stored in the average temporary storage unit 16 according to the acquired imaging conditions. Accordingly, according to the present embodiment, it is possible to adjust the average values according to change of the imaging conditions. As a result, according to the present embodiment, even when the imaging conditions change, it is possible to continue to calculate the moving average value.

### Fourth Embodiment

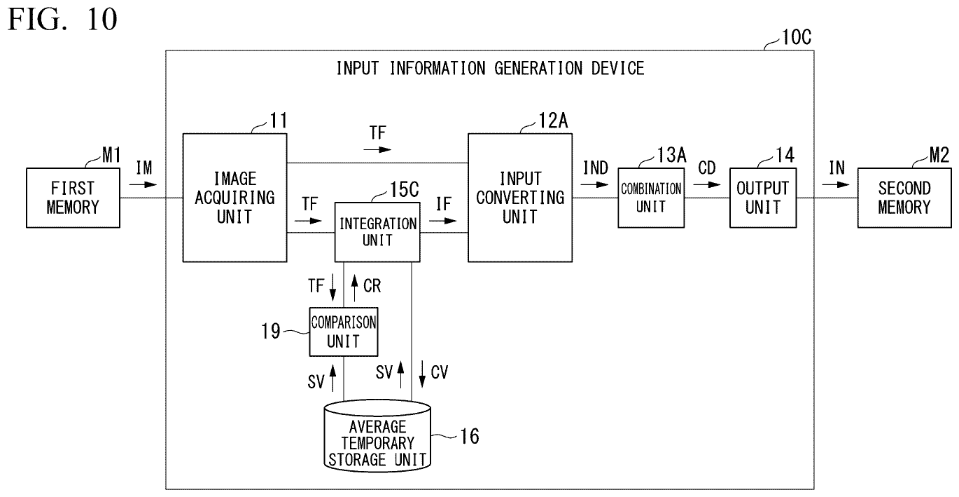

A fourth embodiment will be described below with reference to FIG. 10. Problems to be solved by the fourth embodiment will be first described. The input information generation device 10B according to the third embodiment includes the average temporary storage unit 16 to calculate a moving average. According to the third embodiment, the integration unit 15B calculates a moving average of the whole image. The input information generation device 10B generates input data IN on the basis of a target frame TF and a moving average, and the CNN 200 removes noise in the video on the basis of the generated input data IN. Since the integration unit 15B calculates the moving average of the whole image, when a moving subject is imaged in a part of the video, there may be a problem in that an afterimage is generated in a part in which the moving subject is imaged as a result of noise removal. The fourth embodiment is for solving this problem.

FIG. 10 is a block diagram illustrating an example of a functional configuration for input information generation according to the fourth embodiment. An example of the functional configuration of an input information generation device 10C according to the fourth embodiment will be described below with reference to this drawing. The input information generation device 10C is different from the input information generation device 10B, in that a comparison unit 19 is additionally provided and an integration unit 15C is provided instead of the integration unit 15B. The input information generation device 10C may include the imaging condition acquiring unit 17 and the adjustment unit 18 similarly to the input information generation device 10B, but may not include them. In the illustrated example, it is assumed that the input information generation device 10C does not include the imaging condition acquiring unit 17 and the adjustment unit 18. In description of the input information generation device 10C, the same elements as in the input information generation device 10B will be referred to by the same reference signs, and thus description thereof may be omitted.

The comparison unit 19 acquires a stored value SV from the average temporary storage unit 16 and acquires a target frame TF from the integration unit 15C. The comparison unit 19 compares pixel values of the acquired target frame TF with the acquired stored values stored in the average temporary storage unit 16. The comparison unit 19 may perform comparison on the whole image, comparison for each pixel, or comparison for each patch including a plurality of pixels. The comparison unit 19 outputs the result of comparison as a comparison result CR to the integration unit 15C. The comparison result CR may include differences between the pixel values and may include information on a result of comparison between the differences and a predetermined threshold value.

The integration unit 15C acquires the comparison result CR from the comparison unit 19 and acquires the stored values SV from the average temporary storage unit 16. When a difference therebetween is equal to or less than a predetermined value on the basis of the comparison result CR which is the result of comparison from the comparison unit 19, the integration unit 15C calculates a moving average based on the stored values SV stored in the average temporary storage unit 16 and the average values of the target frame TF. The integration unit 15C sets the calculated values as pixel values of an integrated frame IF. When the difference therebetween is not equal to or less than a predetermined value on the basis of the comparison result CR which is the result of comparison from the comparison unit 19, the integration unit 15C sets the pixel values of the target frame TF as the pixel values of the integrated frame IF.

The integration process in the integration unit 15C may be performed on the whole image, on each pixel, or for each patch including a plurality of pixels. When the integration process is performed for each pixel or for each patch, the pixel values of the integrated frame IF are moving average values at positions at which the difference is equal to or less than a predetermined value (that is, at positions with a small motion) and are the pixel values of the target frame TF at positions at which the difference is not equal to or less than the predetermined value (that is, positions with a large motion). The integration unit 15C stores the result of calculation as a calculated value CV in the average temporary storage unit 16. In the input information generation device 10C, a subject with a large motion is not included in an average image, and the background with a small motion is included in the average image. The arithmetic operation performed by the input information generation device 10C may also be said to be selective averaging.

In a modified example of the process performed by the integration unit 15C, multiplication by a coefficient may be performed instead of selecting whether a subject is to be included in an average image. For example, when the difference is equal to or less than the predetermined value as the comparison result which is a result of comparison from the comparison unit 19, the integration unit 15C may calculate a moving average based on values obtained by multiplying the stored values SV stored in the average temporary storage unit 16 by a predetermined coefficient (for example, 0.9) and the average values of the target frame TF and use the calculated moving average as the pixel values of the integrated frame IF. When the difference is not equal to or less than the predetermined value on the basis of the comparison result CR which is the result of comparison from the comparison unit 19, the integration unit 15C may calculate a moving average based on values obtained by multiplying the stored values SV stored in the average temporary storage unit 16 by a predetermined coefficient (for example, 0.1) and the average values of the target frame TF and use the calculated moving average as the pixel values of the integrated frame IF.

### Summary of Fourth Embodiment

According to the aforementioned embodiment, the input information generation device 10C further includes the comparison unit 19 to compare pixel values of a target frame TF with the storage values SV stored in the average temporary storage unit 16. When the difference is equal to or less than the predetermined value as the result of comparison from the comparison unit 19, the integration unit 15C calculates the pixel values of the integrated frame TF by calculating a moving average based on the stored values SV stored in the average temporary storage unit 16 and the target frame TF. When the difference is not equal to or less than the predetermined value as the result of comparison from the comparison unit 19, the integration unit 15C sets the pixel values of the target frame TF as the pixel values of the integrated frame IF. That is, the input information generation device 10C determines the pixel values of the integrated frame IF by distinguishing a subject with a large motion and a background with a small motion and selectively performing an averaging process. The input information generation device 10C generates input data IN on the basis of the target frame TF and the integrated frame IF. Accordingly, according to the present embodiment, regarding positions with a large motion, since the pixel values of the adjacent frames AF are not reflected in the pixel values of the integrated frame IF, it is possible to curb a problem that an afterimage occurs.

In the second to fourth embodiments, a predetermined arithmetic operation for determining the pixel values of the integrated frame IF is required, and thus the computational load may become heavier. In order to make the computational load lighter, one frame of frames (for example, two frames before and after) adjacent to the target frame TF may be identified through a predetermined algorithm and be used as the integrated frame IF. The predetermined algorithm may be for randomly identifying one frame out of the frames adjacent to the target frame TF. In this case, the integration unit 15 sets the frame randomly identified out of the adjacent frames AF acquired by the image acquiring unit 11 as the integrated frame IF.

### Other Examples

In the aforementioned embodiment, the combination unit 13 and the integration unit 15 perform processes of combining and integrating a plurality of acquired frames. However, the present embodiment is not limited to this example, and targets to be combined or integrated are not limited to only a plurality of frames. In another example, a combination process and an integration process may be performed on an intermediate output in at least a part of the CNN 200. More specifically, an intermediate output which is generated when a target frame TF and an adjacent frame AF are processed by the CNN 200 may be used as targets to be combined or integrated. An intermediate output which is generated when an adjacent frame AF is processed by the CNN 200 and a vectorization result of a target frame TF may be used as targets to be combined or integrated. The present embodiment is not limited to this example, and all information acquired as a result of process based on frames is widely included as the targets to be combined or integrated.

An aspect of the present embodiment is not limited to an aspect of any one of the first to fourth embodiments, and one of the first to fourth embodiments may be selectively used on the basis of predetermined conditions. The predetermined conditions may include imaging conditions, an imaging mode, and exposure conditions of a video and a type of a subject.

An example in which an arithmetic operation is performed using adjacent frames AF in order to enhance the quality of a target frame TF has been described above, and it is preferable that learning be performed using the adjacent frames AF in addition to the target frame TF similarly to any one of the first to fourth embodiments when a learning model included in the CNN 200 is trained. The arithmetic operation associated with learning does not have to be performed by the image processing device 2, and results such as parameters having been learned by a dedicated learning device may be included as a learning model in the CNN 200.

While the present invention has been described above in conjunction with embodiments, the present invention is not limited to these embodiments, and various modifications and substitutions can be added thereto without departing the gist of the present invention.

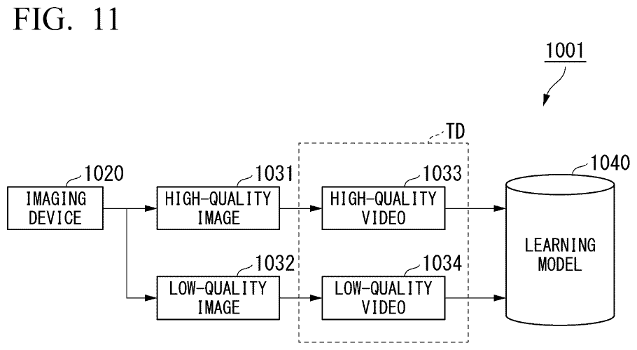

Exemplary embodiments of a learning device, a program, and a learning method for a noise reduction device according to an aspect of the present invention will be described below in detail with reference to FIGS. 11 to 20. The aspect of the present invention is not limited to such embodiments and includes various modifications or improvements thereof. That is, elements described below include elements that can be easily thought out by those skilled in the art or elements that are substantially the same, and elements described below can be appropriately combined. Various omissions, substitutions, or modifications of elements can be carried out without departing from the gist of the present invention. In the drawings used for the following description, sizes, numbers, and the like of constituent members may be made to be different from actual sizes, numbers, and the like of the constituent members in order to make the constituent members be easily recognized.

The background art of the present invention and problems to be solved by the present invention will be first described below.

In the related art, techniques of processing an image from a low-quality image to a high-quality image using machine learning are known. In the related art, a learning model is trained using a combination of a noise image on which noise is superimposed and a high-quality image as training data. Preparation of training data is performed by imaging the same object at different exposure settings using an imaging device to acquire a high-quality image and a noise image. In general, it is known to require a large amount of training data for machine learning, and there is a problem in that preparation of training data through imaging using a camera is troublesome. Therefore, a technique of preparing training data by adding random noise to a high-quality image is known (for example, see Japanese Unexamined Patent Application, First Publication No. 2021-071936). It is known that training data for inferring a high-quality image from a low-quality image is prepared by adding random noise on the high-quality image according to the related art.

Here, similarly to the aforementioned case of a still image, it is known that a large amount of training data for machine learning is required even when image processing is performed from a low-quality video to a high-quality video. However, in case of a video, it is very difficult to image the same subject at different settings and to easily process a high-quality video and a low-quality video in which the same subject is imaged. Therefore, it is conceivable that noise be superimposed on frames of a high-quality video which has been captured in advance to generate a low-quality video by applying the aforementioned related art, but there is a problem in that capacity becomes more enormous, which causes much difficulties.

Therefore, an objective of the present invention is to provide a technique capable of generating training data for inferring a high-quality video from a low-quality video.

The premises of the present embodiments will be described below. In a learning device, a program, and a learning method for a noise reduction device according to the present embodiments, a learning model is trained to infer a high-quality video with reduced noise using low-quality video information with noise superimposed thereon as an input. The low-quality video includes a video with low image quality, and the high-quality video includes a video with high image quality. In the learning device, the program, and the learning method for a noise reduction device according to the present embodiments, training data used for learning is generated from a still image obtained by imaging a subject. The still image obtained by imaging a subject may be one high-quality image or a plurality of images (a combination of one or more high-quality images and one or more low-quality images) obtained by imaging the same subject. The plurality of images obtained by imaging the same subject may be captured under different imaging conditions. An image obtained by imaging a subject may be other images including at least one image. The high-quality image is, for example, an image with high image quality which is captured with low ISO sensitivity and long-second exposure. In the following description, the high-quality image may be referred to as ground truth (GT). The low-quality image is, for example, an image with low image quality which is captured with high ISO sensitivity and short-second exposure.

In the following description, deterioration in image quality due to noise is mentioned as an example of a low-quality image, and these embodiments can be widely applied to factors causing quality deterioration of an image in addition to noise. Examples of the factors causing quality deterioration of an image include deterioration in resolution or color shift due to an optical aberration, deterioration in resolution due to camera shake or subject blurring, unevenness in black level due to a dark current or a circuit, a ghost or a flare due to a subject with high luminance, and signal level abnormality.

An image which has been prepared in advance may be used to generate training data. In the following description, a low-quality image may be referred to as an image with low image quality or a noisy image. In the following description, a high-quality image may be referred to as an image with high image quality or GT. Similarly, a low-quality video may be referred to as a video with low image quality or a noisy video. In the following description, a high-quality video may be referred to as a video with high image quality or GT.

An image which is to be learned by the learning device according to the present embodiment may be a still image or a frame included in a video. A data format thereof may be a format in which a compression and encoding process has not been performed such as a raw format or may be a format in which a compression and encoding process has been performed such as a JPEG format or an MPEG format. In the following description, an image is a still image in the raw format unless mentioned otherwise.

An image which is to be learned by the learning device according to the present embodiment may be an image which is captured by a charge-coupled device (CCD) camera employing a CCD image sensor. An image which is to be learned by the learning device according to the present embodiment may be an image which is captured by a complementary metal oxide semiconductor (CMOS) camera employing a CMOS image sensor. An image which is to be learned by the learning device according to the present embodiment may be a color image or may be a monochromatic image. An image which is to be learned by the learning device according to the present embodiment may be an image which is captured by a camera acquiring non-visible components such as an infrared camera using an infrared sensor.

### Fifth Embodiment

A fifth embodiment will be first described with reference to FIGS. 11 to 18.

FIG. 11 is a diagram schematically illustrating a learning system according to the fifth embodiment. The learning system 1001 will be schematically described with reference to the drawing. The learning system 1001 illustrated in the drawing is an example of a configuration in a learning stage of machine learning. The learning system 1001 trains a learning model 1040 using training data TD which is generated on the basis of an image captured by an imaging device 1020.

The learning system 1001 includes the imaging device 1020 to capture a high-quality image 1031 and a low-quality image 1032. The high-quality image 1031 and the low-quality image 1032 are images in which the same subject is imaged. For example, the high-quality image 1031 and the low-quality image 1032 are captured at different settings such as ISO sensitivity and exposure time at the same angle of view and the same imaging angle. The number of high-quality images 1031 is preferably one, but may be two or more. The number of low-quality images 1032 is preferably two or more, but may be one. The two or more low-quality images 1032 are preferably different images which are captured at different settings such as ISO sensitivity or exposure time. The imaging device 1020 may be, for example, a smartphone or a tablet terminal including a communication means. The imaging device 1020 may be a monitoring camera including a communication means.

The learning system 1001 generates a high-quality image 1033 from the high-quality images 1031 and generates a low-quality image 1034 from the low-quality images 1032. The high-quality image 1033 is preferably generated from one high-quality image 1031, and the low-quality image 1034 is preferably generated from two or more low-quality image 1032. The high-quality image 1033 and the low-quality image 1034 which are generated from the high-quality image 1031 and the low-quality images 1032 in which the same subject is imaged are correlated with each other. The high-quality image 1033 and the low-quality image 1034 correlated with each other are input as training data TD to a learning model 1040 for learning.

The high-quality image 1033 and the low-quality image 1034 correlated with each other may be temporarily stored in a predetermined storage device for learning which will be performed later. That is, the learning system 1001 may generate a plurality of pieces of training data TD in advance before the learning which will be performed later. The high-quality image 1031 and the low-quality images 1032 captured by the imaging device 1020 may be temporarily stored in a predetermined storage device. In this case, the learning system 1001 may store a plurality of combinations of the high-quality image 1031 and the low-quality image 1032 correlated with each other and generate training data TD at the time of learning.

The learning model 1040 is trained using the training data TD generated by the learning system 1001. Specifically, the learning model 1040 is trained to infer a high-quality video from a low-quality video. In other words, the learning model 1040 after learning infers a high-quality video with the low-quality video as an input and outputs the result of inference. That is, the learning model 1040 after learning may be used for a noise reduction device for reducing noise from a low-quality video.

The high-quality image 1031 and the low-quality images 1032 captured by the imaging device 1020 are stored in a predetermined storage device that temporarily stores information. The predetermined storage device may be provided in the imaging device 1020 or may be provided in a cloud server or the like. That is, the learning system 1001 may be provided in an edge device or may be configured to include an edge device and a cloud server. A GPU which is provided in a server or the like may be used for learning of the learning model 1040.

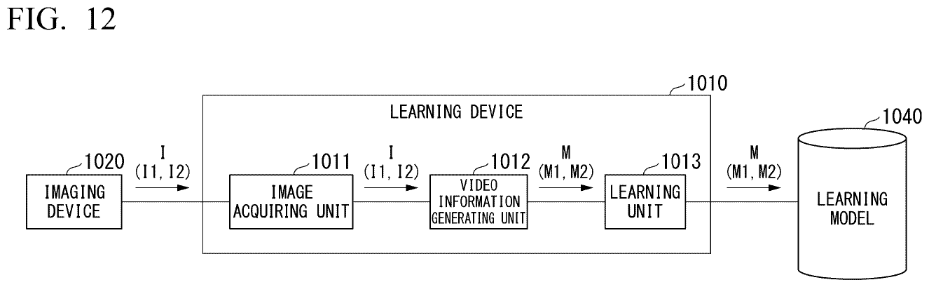

FIG. 12 is a diagram illustrating an example of the functional configuration of a learning device according to the fifth embodiment. The functional configuration of the learning device 1010 will be described below with reference to the drawing. The learning device 1010 is used to realize the learning system 1001. The learning device 1010 generates a high-quality image 1033 and a low-quality image 1034 on the basis of the high-quality image 1031 and the low-quality images 1032 captured by the imaging device 1020. The learning device 1010 trains the learning model 1040 using the generated high-quality image 1033 and the generated low-quality image 1034 as training data TD. The learning device 1010 includes an image acquiring unit 1011, a video information generating unit 1012, and a learning unit 1013. The learning device 1010 includes a central processing unit (CPU) or a storage device such as a read only memory (ROM) or a random access memory (RAM) which are not illustrated and which are connected via a bus. The learning device 1010 serves as a device including the image acquiring unit 1011, the video information generating unit 1012, and the learning unit 1013 by executing a learning program.

All or some of the functions of the learning device 1010 may be realized by hardware such as an application-specific integrated circuit (ASIC), a programmable logic device (PLD), or a field-programmable gate array (FPGA). The learning program may be recorded on a computer-readable recording medium. The computer-readable recording medium is, for example, a portable medium such as a flexible disk, a magneto-optical disk, a ROM, or a CD-ROM or a storage device such as a hard disk incorporated into a computer system. The learning program may be transmitted via an electrical communication line.

The image acquiring unit 1011 acquires image information I from the imaging device 1020. The image information I includes first image information I1 and second image information I2. The first image information I1 includes at least one high-quality image 1031. The second image information I2 includes at least one low-quality image 1032. In the low-quality image 1032 included in the second image information I2, the same subject as a subject imaged in the high-quality image 1031 included in the first image information I1 is imaged. An image included in the second image information I2 has lower image quality than the image included in the first image information I1. The image acquiring unit 1011 outputs the acquired image information I to the video information generating unit 1012.

The video information generating unit 1012 cuts out a plurality of parts of the image included in the image information I and generates video information M by connecting the cut-out images as frame images at a predetermined time interval (or which may also be referred to as a frame rate). The frame rate may be, for example, 60 [frames per second (FPS)]. Positions of the images cut-out by the video information generating unit 1012 may be different between frames. For example, with a size of cut-out images fixed, the video information generating unit 1012 may cut out a plurality of images at positions which are shifted in a predetermined direction by predetermined pixels (a number of bits). Specifically, the sizes of the cut-out images may be fixed to 256 pixels×256 pixels. The video information generating unit 1012 may cut out images at positions at which the size is shifted by 10 pixels for each frame. When the amount of shift is excessively large, an amount of change of an image between frames becomes excessively large, which causes an unnatural video. Accordingly, it is preferable to provide a limit (an upper limit) such that the size is not shifted by a predetermined amount or more. The amount of shift or the limit is preferably determined on the basis of the imaging angle, the imaging resolution, the focal distance of an optical system, the distance to a subject, the imaging frame rate, and the like. Regarding a subject which is falling or the like, since the speed thereof increases in an acceleration manner, the amount of shift thereof may be increased by a frame (a degree) temporally separated from a target image.

The video information generating unit 1012 generates first video information M1 from the image included in the first image information I1 and generates second video information M2 from the image included in the second image information I2. That is, the video information generating unit 1012 cuts out a plurality of images at different positions as parts of the first image information I1 and generates the first video information M1 by combining the plurality of cut-out images. The video information generating unit 1012 cuts out a plurality of images at different positions as parts of the second image information I2 and generates the second video information M2 by combining the plurality of cut-out images. Generation of a video by combining a plurality of images may be converting the plurality of images to a file format in which images are displayed at a predetermined time interval corresponding to a frame rate.

The video information generating unit 1012 outputs information including the generated first video information M1 and the generated second video information M2 as video information M to the learning unit 1013.

Here, the sizes of the plurality of images cut out by the video information generating unit 1012 or the positions thereof may be arbitrarily determined. However, the positions at which the images are cut out from the image included in the first image information I1 and the positions at which the image are cut out from the image included in the second image information I2 are preferably substantially the same positions. This is because the first video information M1 which is a video with high image quality and the second video information M2 which is a video with low image quality have to image the same subject.

The learning unit 1013 acquires the video information M from the video information generating unit 1012. The learning unit 1013 trains the learning model 1040 by inputting the acquired video information M as training data TD to the learning model 1040. The learning model 1040 is trained to infer a high-quality video from a low-quality video. That is, the learning unit 1013 performs training to infer a high-quality video from a low-quality video on the basis of the first video information M1 and the second video information M2 generated by the video information generating unit 1012. The learning model 1040 can also be said to be trained to remove noise from an input video.

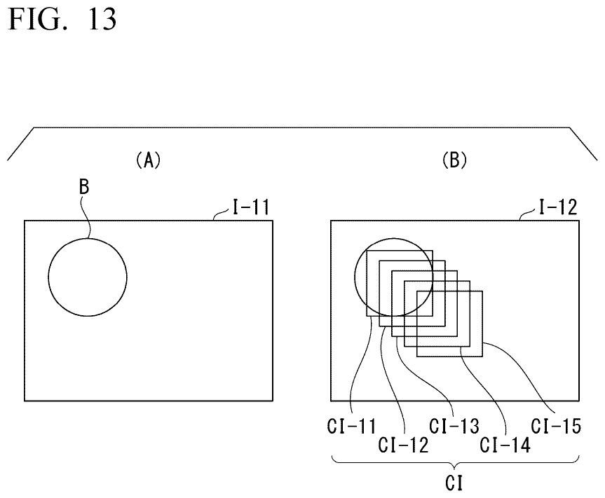

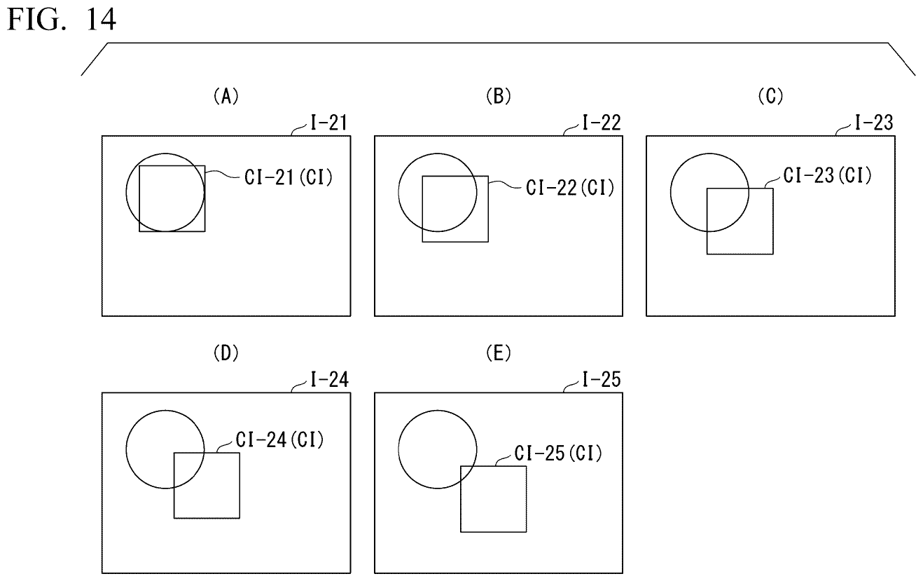

Images which the learning device 1010 cuts out from an image captured by the imaging device 1020 will be described below with reference to FIGS. 13 to 15. In the following description, a method of generating a high-quality video from a high-quality image (a method which will be described with reference to FIG. 13) and a method of generating a low-quality video from a low-quality image (a method which will be described with reference to FIG. 14) are different, but the present embodiment is not limited to this example. Instead of the following description, a high-quality video may be generated from a high-quality image and a low-quality video may be generated from a low-quality image using the same method. That is, a low-quality video may be generated using the method which will be described with reference to FIG. 13, and a high-quality video may be generated using the method which will be described with reference to FIG. 14.

FIG. 13 is a diagram illustrating an example of positions of images which are cut out from a high-quality image by the learning device according to the fifth embodiment. An example of positions of images cut out from a high-quality image by the learning device 1010 will be described below with reference to the drawing. FIG. 13 in (A) illustrates an image I-11 which is an example of an image included in the first image information I1. In FIG. 13 in (B), an example when a plurality of images are cut out from the image I-11 illustrated in FIG. 13 in (A) is illustrated an image I-12.

As illustrated in FIG. 13 in (A), a ball B which is a subject is imaged in the image I-11. The video information generating unit 1012 cuts out a plurality of images from the image I-11 and generates a video from the image I-11 which is a still image by temporally connecting the cut-out images.

The image I-12 illustrated in FIG. 13 in (B) includes a plurality of cut-out images CI which are images cut out by the video information generating unit 1012. Specifically, cut-out images CI-11 to CI-15 are illustrated as an example of images cut out by the video information generating unit 1012. The cut-out images CI-11 to CI-15 may be referred to as cut-out images CI when they are not distinguished from each other.

The cut-out images CI-11 to CI-15 are shifted by a predetermined number of pixels in the vertical direction and the horizontal direction. With the first video information M1 generated by the video information generating unit 1012, an image C-11 appears at certain time t1, an image C-12 appears at certain time t2, an image C-13 appears at certain time t3, an image C-14 appears at certain time t4, and an image C-15 appears at certain time t5. In this way, by temporally connecting different cut-out images CI, a video in which the ball B which is a subject in a still image seems to move can be generated. When the video information generating unit 1012 generates a video at a frame rate of 60 [fps], the interval between the times may be 1/60 seconds.

The shift direction and the amount of shift of images cut out by the video information generating unit 1012 can be preferably determined on the basis of imaging conditions such as an imaging angle of view, an imaging resolution, a focal distance of an optical system, a distance to a subject, and an imaging frame rate. When a subject which is a falling object is simulated, the speed thereof increases in an acceleration manner, and thus it is preferable to gradually change (increase) the amount of shift.

Here, the high-quality video (the first video information M1) generated by the learning device 1010 is a video with high image quality on which noise is not superimposed. Accordingly, it is ideal that noise is not superimposed on an image which is a still image used to generate a video. It is also ideal that noise is not superimposed on each frame of a high-quality video generated from the image on which noise is not superimposed. Accordingly, it is preferable that the video information generating unit 1012 generate a video from one image on which noise is not superimposed. That is, the video information generating unit 1012 can preferably generate the first video information M1 by cutting out different parts from one image with high quality included in the first image information I1.

FIG. 14 is a diagram illustrating an example of positions of images which are cut out from a low-quality image by the learning device according to the fifth embodiment. An example of positions of images cut out from a low-quality image by the learning device 1010 will be described below with reference to the drawing. The learning device 1010 cuts out images of different frames from a plurality of low-quality images. In FIG. 14 in (A) to 14 in (E), images I-21 to I-25 which are different images are illustrated. The learning device 1010 cuts out images of different frames from the images I-21 to I-25.

The composition of the images I-21 to I-25 which are low-quality images is the same as the composition of the image I-11 illustrated in FIG. 13 in (A). That is, in the images I-21 to I-25, the ball B appears at the same position. The images I-21 to I-25 are different from the image I-11 in that different noise is superimposed thereon. For example, by using different imaging conditions at the time of capturing an image, different noise may be superimposed on the images I-21 to I-25.

The video information generating unit 1012 cuts out a cut-out image CI-21 from the image I-21, cuts out a cut-out image CI-22 from the image I-22, cuts out a cut-out image CI-23 from the image I-23, cuts out a cut-out image CI-24 from the image I-24, and cuts out a cut-out image CI-25 from the image I-25. The cut-out images CI-21 to CI-25 are shifted by a predetermined number of pixels in the vertical direction and the horizontal direction. With the second video information M2 generated by the video information generating unit 1012, an image C-21 appears at certain time t1, an image C-22 appears at certain time t2, an image C-23 appears at certain time t3, an image C-24 appears at certain time t4, and an image C-25 appears at certain time t5. Since different noise is superimposed on the cut-out images CI-21 to CI-25, noise which is temporally different is also superimposed on a video which is generated.

Here, the low-quality video (the second video information M2) generated by the learning device 1010 is a video with low image quality because noise is superimposed thereon. When a plurality of different positions are cut out from one image on which noise is superimposed to generate a video, the same noise is included at any time (in other words, noise does not vary temporally), and thus the video may not be appropriate as a video with low image quality. Accordingly, in the present embodiment, a video with low image quality is generated by cutting out images from a plurality of different low-quality images. The same subject as a subject imaged in a high-quality image is imaged in the plurality of different images with low image quality. That is, the second image information M2 includes a plurality of images on which different noise is superimposed as a plurality of images in which the same subject as a subject imaged in the image included in the first image information I1 is imaged are included in the second image information M2. The plurality of images included in the second image information I2 may be images which are captured at proximately different times. The video information generating unit 1012 generates the second video information M2 by cutting out different parts from the plurality of images included in the second image information.

For example, instead of preparing low-quality images corresponding to several frames, an image may be cut out from a plurality of images such that they are not successive. The order of cutting an image from a plurality of images may be random.

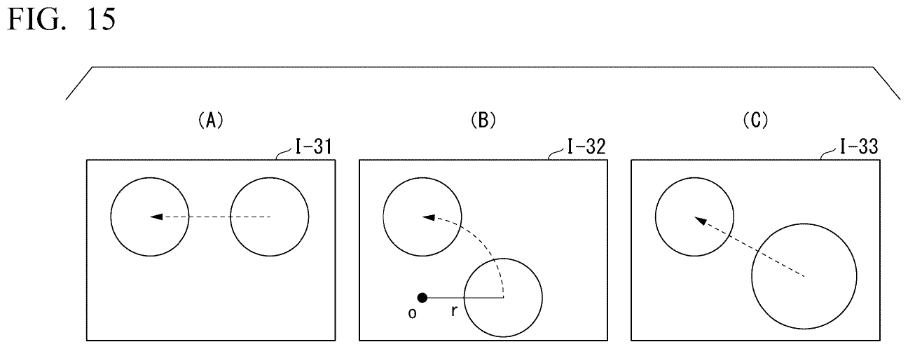

FIG. 15 is a diagram illustrating an example of a direction in which an image is cut out by the learning device according to the fifth embodiment. In the example described above with reference to FIGS. 13 and 14, an image is cut out at positions which are shifted by a predetermined number of pixels in the vertical direction and the horizontal direction. However, the video information generating unit 1012 may cut out an image at positions which are shifted in other directions. Another example of the direction in which cut-out images CI are cut out by the video information generating unit 1012 will be described below with reference to FIG. 15 in (A) to 15 in (C).

An image I-31 is illustrated in FIG. 15 in (A). FIG. 15 in (A) illustrates an example in which an image is cut out at a position which is shifted in only the horizontal direction (horizontal direction). In this case, the video information generating unit 1012 cuts out the cut-out images CI at a plurality of different positions by fixing the y coordinates in the vertical direction and changing only the x coordinates in the horizontal direction. Through this cutting-out, it is possible to generate a video in which a subject seems to move in the horizontal direction (horizontal movement). Similarly, the video information generating unit 1012 may cut out the cut-out image CI at a position shifted in only the vertical direction (vertical direction). Through this cutting-out, it is possible to generate a video in which a subject seems to move in the vertical direction (vertical movement).

As illustrated in FIGS. 13 and 14, the video information generating unit 1012 may cut out the cut-out images CI at positions which are shifted in both of the vertical direction and the horizontal direction. In this case, the amount of shift in the vertical direction and the amount of shift in the horizontal direction may be different from each other.

An image I-32 is illustrated in FIG. 15 in (B). FIG. 15 in (B) illustrates an example in which an image is cut out at a position which is shifted in a rotational direction. In this case, the video information generating unit 1012 cuts out the cut-out images CI at a plurality of different positions by shifting the cut-out position in an arc shape with a rotation center O and with a radius r. In the example illustrated in this drawing, the video information generating unit 1012 cuts out an image at positions which rotates counterclockwise. Through this cutting-out, it is possible to generate a video in which a subject seems to move in the rotational direction. The position of the rotation center O or the size of the radius r may vary depending on frames.

An image I-33 is illustrated in FIG. 15 in (C). FIG. 15 in (C) illustrates an example in which the cut-out position is enlarged and reduced. In the present embodiment, the size of the cut-out images CI are preferably to be fixed. Accordingly, the video information generating unit 1012 cuts out the cut-out images CI by enlarging or reducing the image I while fixing the sizes of the cut-out images CI. When the sizes of the cut-out images CI are fixed to 256 pixels×256 pixels, the video information generating unit 1012 enlarges or reduces the image I such that the image is less than the size of the cut-out images CI. Through this cutting-out, it is possible to generate a video in which a subject seems to zoom in or zoom out.

The cut-out positions described above with reference to FIG. 15 in (A) to 15 in (C) are an example of the present embodiment, and the video information generating unit 1012 may generate video information by cutting out and connecting images at other different positions. The video information generating unit 1012 may cut out the cut-out images CI, for example, by combining the cutting-out methods described above with reference to FIG. 15 in (A) to 15 in (C). In this case, for example, it is possible to generate a video in which a subject moves horizontally or vertically and then moves rotationally or a subject moves and then is enlarged or reduced.

The aforementioned shift of the cut-out positions may be calculated by an affine transformation. That is, the predetermined direction in which the video information generating unit 1012 cuts out an image can also be said to be calculated through an affine transformation.

Instead of the aforementioned example in which the cut-out position is shifted, the video information generating unit 1012 may generate a video by cutting out a part of an image and then moving the part. In this case, the video information generating unit 1012 cuts out an image of 256 pixels×256 pixels and generates a plurality of pixels by moving the cut-out image in a predetermined direction. The video information generating unit 1012 generates a video by connecting the cut-out images. That is, the video information generating unit 1012 may cut out a plurality of images at different positions by shifting the plurality of cut-out images in the predetermined direction.

By cutting out an image and then shifting the image, an area in which data is not present may be formed in the periphery of the image. However, a peripheral part of the image can be excluded from a range of an image to be learned by defining the peripheral part as an overlap part in advance such that a problem does not occur in a subsequent learning stage.

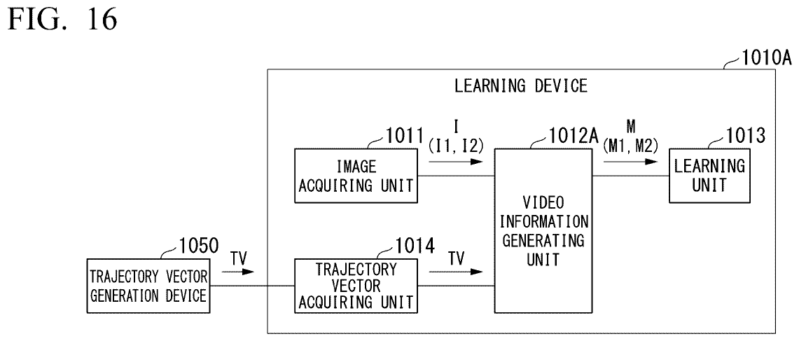

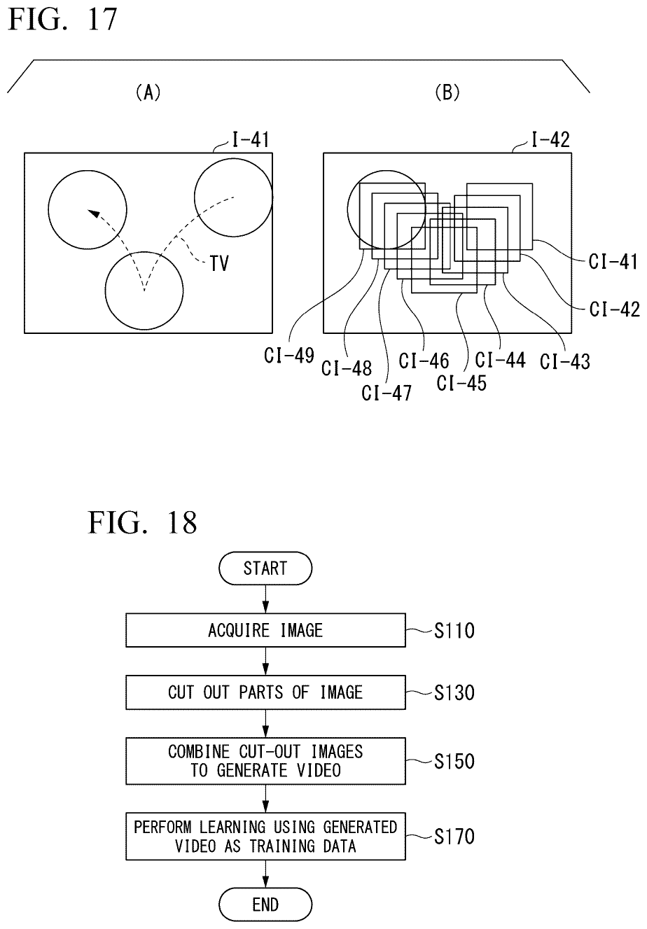

In the above description, an example in which the video information generating unit 1012 generates a video by cutting out an image shifted in a direction which is calculated using a certain method such as an affine transformation has been described. However, in real videos, a subject may not often move in the calculated direction and may often move rather randomly. Accordingly, the learning device 1010 can generate a video by cutting out an image shifted in a direction based on a trajectory along which an object moves actually and thus generate training data which is more effective for machine learning. An example in this case will be described below as a modified example of the fifth embodiment with reference to FIGS. 16 and 17.

Here, in a bright scene such as fine weather, it is general to increase a shutter speed in order to maintain exposure. Accordingly, it is known that smoothness of a moving subject disappears and a video becomes rough. Similarly, when a video is prepared from a still image with a high resolution, the video may become rough and unnatural with less smoothness. Accordingly, the video information generating unit 1012 may perform correction of adding similar subject blurring to the still image from which a video is to be generated and then generate the video. For example, subject blurring may be added by performing a predetermined averaging process in the shift direction or performing a process of decreasing a resolution.

FIG. 16 is a diagram illustrating an example of a functional configuration of a learning device according to a modified example of the fifth embodiment when the learning device generates a video on the basis of a trajectory vector. An example of the functional configuration of a learning device 1010A according to the modified example of the fifth embodiment will be described below with reference to this drawing. A learning system 1001A according to the modified example of the fifth embodiment is different from the learning system 1001 in that a trajectory vector generation device 1050 is further provided. The learning device 1010A is different from the learning device 1010 in that a trajectory vector acquiring unit 1014 is further provided. The learning device 1010A is different from the learning device 1010 in that a video information generating unit 1012A is provided instead of the video information generating unit 1012. In description of the learning device 1010A, the same elements as in the learning device 1010 will be referred to by the same reference signs, and description thereof may be omitted.

The trajectory vector generation device 1050 acquires information on a trajectory of an object which is imaged in a video. Video information is input to the trajectory vector generation device 1050, and the trajectory vector generation device 1050 analyzes the trajectory of the object imaged in the input video information. The trajectory vector generation device 1050 outputs the result of analysis as a trajectory vector TV. The trajectory vector TV represents the trajectory of the object imaged in the video information. The trajectory vector generation device 1050 acquires the trajectory vector TV from the video information, for example, using a known technique such as an optical flow.

The trajectory vector TV may include coordinate information indicating the moving trajectory of the object in addition to or instead of vector information.

The trajectory vector acquiring unit 1014 acquires the trajectory vector TV from the trajectory vector generation device 1050. The trajectory vector acquiring unit 1014 outputs the acquired trajectory vector TV to the video information generating unit 1012A. A video of which the trajectory vector TV is acquired by the trajectory vector generation device 1050 and an image acquired by the image acquiring unit 1011 may have a predetermined relationship. In this case, for example, the image acquiring unit 1011 may acquire one frame of the video of which the trajectory vector TV has been acquired by the trajectory vector generation device 1050 as an image.

However, the present embodiment is not limited to this example, and the video of which the trajectory vector TV has been acquired by the trajectory vector generation device 1050 and the video acquired by the image acquiring unit 1011 may not have a predetermined relationship.

The video information generating unit 1012A acquires image information I from the image acquiring unit 1011 and acquires the trajectory vector TV from the trajectory vector acquiring unit 1014. The video information generating unit 1012A generates video information on the basis of the acquired image information I and the acquired trajectory vector TV. The video information generating unit 1012A determines a cut-out direction of cut-out images CI or an amount of shift per frame on the basis of a trajectory indicated by the trajectory vector TV. That is, the predetermined direction in which an image is cut out by the video information generating unit 1012A is calculated on the basis of the acquired trajectory vector TV.

FIG. 17 is a diagram illustrating an example of positions of images which are cut out from a still image when a learning device according to a modified example of the fifth embodiment generates a video on the basis of a trajectory vector. An example of positional coordinates of cut-out images CI when a video is generated on the basis of a trajectory vector TV will be described below with reference to this drawing. FIG. 17 in (A) illustrates an image I-41 which is an example of an image included in the first image information I1. FIG. 17 in (B) illustrates an example of a plurality of cut-out images CI which are cut out from the image I-41.

As illustrated in FIG. 17 in (A), a trajectory vector TV which is a trajectory of a ball B which is a subject is illustrated in the image I-41. The trajectory vector TV is a vector indicating that the ball B falls down at the center from the upper-right side in the drawing, is bounded down at the center, and then moves to the upper-left side in the drawing. The video information generating unit 1012A generates a video from the image I-41 which is a still image by cutting out cut-out images CI at the positional coordinates based on the trajectory vector TV illustrated in the image I-41 and temporally connecting the cut-out images.

FIG. 17 in (B) illustrates an example of the cut-out images CI which are images cut out by the video information generating unit 1012. Specifically, cut-out images CI-41 to CI-49 are illustrated as an example of the images cut out by the video information generating unit 1012. The cut-out images CI-41 to CI-49 are located at coordinates based on the trajectory vector TV. That is, the cut-out image CI-41 is located on the upper-right side in the drawing, and the cut-out positions to the cut-out image CI-45 move down at the center in the drawing. The cut-out positions move to the upper-left side in the drawing from the cut-out image CI-45 to the cut-out image CI-49.

FIG. 18 is a flowchart illustrating an example of an operation flow of a learning method for a noise reduction device according to the fifth embodiment. An example of an operation flow of the learning method for a noise reduction device using the learning device 1010 will be described below with reference to the drawing. (Step S110) First, the image acquiring unit 1011 acquires an image. The image acquiring unit 1011 acquires first image information I1 including a high-quality image and second image information I2 including a low-quality image. The step in which the image acquiring unit 1011 acquires an image may be referred to as an image acquiring step or an image acquiring process.

(Step S130) Then, the video information generating unit 1012 cuts out a part of the acquired image. The video information generating unit 1012 cuts out a plurality of cut-out images CI from the acquired image. The video information generating unit 1012 cuts out a plurality of cut-out images CI from each of a high-quality image included in the first image information I1 and a low-quality image included in the second image information I2. The positional coordinates cut out from each of the high-quality image included in the first image information I1 and the low-quality image included in the second image information I2 are preferably the same. On the other hand, when a timing at which the high-quality image included in the first image information I1 is acquired and a timing at which the low-quality image included in the second image information I2 is acquired are temporally different, a shift due to a time difference may be generated in the subject included in the cut-out images. In this case, it is preferable that the positional coordinates cut out from each of the high-quality image included in the first image information I1 and the low-quality image included in the second image information I2 be determined in consideration of the shift due to a time difference. More specifically, it is preferable that the positional coordinates cut out from the high-quality image included in the first image information I1 or the low-quality image included in the second image information I2 be changed to a direction in which the amount of shift due to the time difference decreases.

(Step S150) Then, the video information generating unit 1012 generates a video by connecting the cut-out images. The video information generating unit 1012 generates a high-quality video by connecting a plurality of images cut out from the high-quality image and generates a low-quality video by connecting a plurality of images cutout from the low-quality image. The step of generating video information in Step S130 and Step S150 may be referred to as a video information generating step or a video information generating process.

(Step S170) Finally, the learning unit 1013 performs training to infer a high-quality video from a low-quality video using a combination of the generated high-quality video and the generated low-quality video as training data TD. This step may be referred to as a learning step or a learning process.

### Summary of Fifth Embodiment

According to the aforementioned embodiment, the learning device 1010 includes the image acquiring unit 1011 to acquire first image information I1 and second image information I2. The first image information I1 includes at least one image, and the second image information I2 includes at least one image with image quality which is lower than the image included in the first image information I1 and in which the same subject as a subject imaged in the image included in the first image information I1 is imaged. The learning device 1010 includes the video information generating unit 1012 to cut out a plurality of images at different positions as a part of the first image information I1 and to combine the plurality of cut-out images to generate first video information M1. Similarly, the learning device 1010 includes the video information generating unit 1012 to cut out a plurality of images at different positions as a part of the second image information I2 and to combine the plurality of cut-out images to generate second video information M2. The learning device 1010 includes the learning unit 1013 to perform learning to infer a high-quality video from a low-quality video on the basis of the training data TD including the first video information M1 and the second video information M2 generated by the video information generating unit 1012. That is, according to the present embodiment, the learning device 1010 does not have to acquire the training data including the low-quality video and the high-quality video which are necessary in the related art through capturing a video and can generate the training data from a still image. Accordingly, according to the present embodiment, it is possible to easily generate training data for inferring a high-quality video from a low-quality video.

According to the present embodiment, the learning device 1010 can generate a plurality of different videos from the same still image. Accordingly, according to the present embodiment, since a large amount of training data TD is generated, it is not necessary to prepare massive still images and it is possible to generate more videos from smaller still images. As a result, according to the present embodiment, it is possible to shorten a time required to capture an image used for learning.

According to the aforementioned embodiment, the second image information I2 includes a plurality of images on which different noise is superimposed as a plurality of images in which the same subject as a subject imaged in the image included in the first image information I1 is imaged. The video information generating unit 1012 generates second video information M2 by cutting out different parts from each of the plurality of images included in the second image information I2. That is, according to the present embodiment, a low-quality video on which noise is superimposed is generated on the basis of a plurality of different low-quality images on which noise is superimposed. Accordingly, noise varying depending on the frames is superimposed on the second video information M2 generated according to the present embodiment, and it is possible to more accurately reproduce and generate a low-quality video on which noise is superimposed.

According to the aforementioned embodiment, a plurality of images included in the second image information I2 are images which are captured at proximately different times. That is, the low-quality images for generating a low-quality video are captured at proximate times. The proximate times may be, for example, 1/60 seconds. Here, in case of a video, unlike a still image, video-specific noise including temporal components may be superimposed. Images captured at proximately different times include this video-specific noise. Accordingly, according to the present embodiment, since the learning device 1010 generates a video on the basis of images captured at proximately different times, it is possible to reproduce and generate video-specific noise including temporal components.

According to the aforementioned embodiment, the video information generating unit 1012 generates the first video information M1 by cutting out different parts from one image included in the first image information I1. That is, according to the present embodiment, a high-quality video is generated on the basis of one image. Accordingly, according to the present embodiment, it is possible to easily generate a high-quality video without capturing many high-quality images.

According to the aforementioned embodiment, the video information generating unit 1012 cuts out a plurality of images at different positions by shifting the plurality of cut-out images by different amounts in a predetermined direction. That is, according to the present embodiment, the learning device 1010 shifts the images in the predetermined direction after having cut out the images. In other words, the learning device 1010 performs a process based on the cut-out small images without performing a process based on a large image after having cut out the images. Accordingly, according to the present embodiment, the learning device 1010 can reduce a computational load.

According to the aforementioned embodiment, the video information generating unit 1012 cuts out a plurality of images at positions shifted by a predetermined number of bits in a predetermined direction. The video information generating unit 1012 generates a video by connecting the cut-out images. That is, a subject imaged in the video generated by the video information generating unit 1012 seems to move in the predetermined direction in the video. Accordingly, according to the present embodiment, it is possible to easily generate a video from still images.

According to the aforementioned embodiment, the predetermined direction in which the video information generating unit 1012 cuts out an image is calculated through an affine transformation. In other words, the predetermined direction in which the video information generating unit 1012 cuts out an image is a direction in which a subjects moves in the video. Accordingly, according to the present embodiment, the learning device 1010 can generate a video in which a subject moves in various directions.

According to the aforementioned embodiment, the learning device 1010 further includes the trajectory vector acquiring unit 1014 to acquire a trajectory vector TV. The predetermined direction in which the video information generating unit 1012 cuts out an image is calculated on the basis of the acquired trajectory vector TV. The trajectory vector TV is information on a vector indicating a trajectory along which a subject moves actually in the actually captured video. Accordingly, according to the present embodiment, it is possible to generate a video based on a trajectory along which a subject moves actually.

### Sixth Embodiment

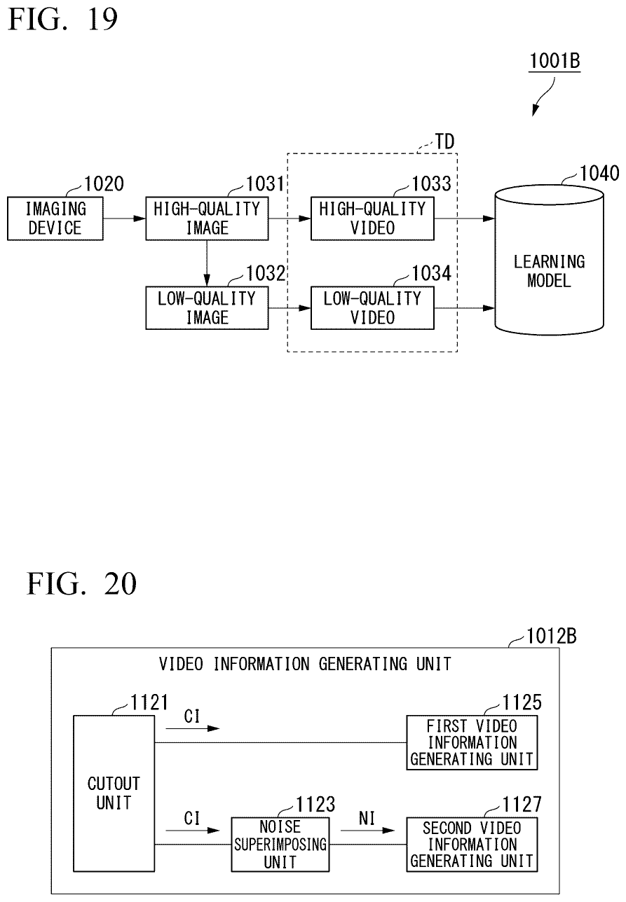

A sixth embodiment will be described below with reference to FIGS. 19 and 20. In the first embodiment, a high-quality image and a low-quality image are necessary, but the sixth embodiment is different from the fifth embodiment in that only a high-quality image is necessary.

FIG. 19 is a diagram schematically illustrating a learning system according to the sixth embodiment. A learning system 1001B according to the sixth embodiment will be schematically described with reference to this drawing. In description with reference to the drawing, the same elements as in the fifth embodiment will be referred to by the same reference signs, and description thereof may be omitted. In the sixth embodiment, the imaging device 1020 captures a high-quality image 1031. A low-quality image 1032 is generated on the basis of the high-quality image 1031 by a learning device 1010B according to the sixth embodiment. The low-quality image 1032 is generated, for example, by superimposing noise thereon through image processing of the high-quality image 1031. That is, according to the present embodiment, the imaging device 1020 captures only the high-quality image 1031 and does not capture a low-quality image 1032.

FIG. 20 is a diagram illustrating an example of a functional configuration of a video information generating unit according to the sixth embodiment. The video information generating unit 1012B provided in the learning device 1010B will be described below with reference to this drawing. The learning device 1010B according to the sixth embodiment is different from the learning device 1010 in that the video information generating unit 1012B is provided instead of the video information generating unit 1012. The video information generating unit 1012B includes a cutout unit 1121, a noise superimposing unit 1123, a first video information generating unit 1125, and a second video information generating unit 1127.

The cutout unit 1121 acquires an image from the image acquiring unit 1011. In the present embodiment, the learning device 1010B acquires a high-quality image from the imaging device 1020, and thus the cutout unit 1121 acquires the high-quality image from the image acquiring unit 1011. The cutout unit 1121 cuts out a plurality of cut-out images CI at different positional coordinates as parts of the acquired high-quality image. The cutout unit 1121 outputs the cut-out images CI to the first video information generating unit 1125 and the noise superimposing unit 1123.

The noise superimposing unit 1123 acquires cut-out images CI cut out by the cutout unit 1121. The noise superimposing unit 1123 superimposes noise on the acquired cut-out images CI. The noise superimposing unit 1123 acquires a plurality of cut-out images CI cut out from a plurality of positional coordinates and superimposes noise on the plurality of acquired cut-out images CI. Noise superimposed by the noise superimposing unit 1123 may be modeled in advance. Examples of the modeled noise include shot noise based on fluctuation of the number of photons, noise which is generated at the time of conversion of light incident on an imaging element to electrons, noise which is generated at the time of conversion of the converted electrons to an analog voltage value, and noise which is generated at the time of conversion of the converted analog voltage value to a digital signal. The intensity of noise which is superimposed may be adjusted using a predetermined method. The noise superimposing unit 1123 can preferably superimpose different noise on the plurality of cut-out images CI. The noise superimposing unit 1123 outputs an image on which noise has been superimposed as a noise image NI to the second video information generating unit 1127.

The first video information generating unit 1125 acquires a plurality of cut-out images CI from the cutout unit 1121. The first video information generating unit 1125 combines the plurality of cut-out images to generate first video information M1. The first video information generating unit 1125 outputs the generated first video information M1 to the learning unit 1013.

The second video information generating unit 1127 acquires a plurality of noise images NI from the noise superimposing unit 1123. The second video information generating unit 1127 combines the plurality of noise images NI on which noise has been superimposed to generate second video information M2. The second video information generating unit 1127 outputs the generated second video information M2 to the learning unit 1013.

The learning unit 1013 acquires the first video information M1 from the first video information generating unit 1125 and acquires the second video information M2 from the second video information generating unit 1127. The learning unit 1013 trains a learning model 1040 on the basis of the first video information M1 and the second video information M2 generated by the video information generating unit 1012B.

### Summary of Sixth Embodiment

According to the aforementioned embodiment, the learning device 1010B includes the image acquiring unit 1011 to acquire image information I including at least one high-quality image. The learning device 1010B includes the video information generating unit 1012B to generate both a high-quality video and a low-quality video from the high-quality image. The video information generating unit 1012B includes the cutout unit 1121 to cut out a plurality of image at different positions as parts of the acquired image information I. The video information generating unit 1012B includes the noise superimposing unit 1123 to superimpose noise on each of the plurality of images cut out by the cutout unit 1121. The video information generating unit 1012B includes the first video information generating unit 1125 to combine the plurality of images cut out by the cutout unit 1121 to generate first video information M1 which is a high-quality video and includes the second video information generating unit 1127 to combine a plurality of images on which noise has been superimposed by the noise superimposing unit 1123 to generate second video information M2. The learning device 1010B includes the learning unit 1013 to preform training to infer a high-quality video from a low-quality video on the basis of the training data TD including the first video information M1 generated by the first video information generating unit 1125 and the second video information M2 generated by the second video information generating unit 1127. That is, the learning device 1010B generates a high-quality video and a low-quality video on the basis of one high-quality image and trains the learning model 1040 to infer a high-quality video from a low-quality video. In other words, inferring of the high-quality video from the low-quality video is noise reduction. Accordingly, according to the present embodiment, it is possible to easily train a noise reduction model without requiring time to acquire the training data TD.

In the sixth embodiment, a high-quality video is generated from a high-quality image, a low-quality image is generated by superimposing noise on the high-quality image, and a low-quality video is generated on the basis of the generated low-quality image. However, the present embodiment is not limited to this example. For example, in a modified example of the present embodiment, the learning device 1010 may prepare training data TD on the basis of only the low-quality images. That is, a low-quality video may be generated from the low-quality images, a high-quality image may be generated by removing noise from the low-quality video, and a high-quality video on the basis of the generated high-quality images. The number of images used to generate a video may be one or two or more.

An example in which the learning device 1010 and the learning device 1010A described above in the fifth embodiment and the learning device 1010B described above in the sixth embodiment are used to train the learning model 1040 for inferring a high-quality video from a low-quality video has been described above, but the present invention is not limited thereto. For example, the learning model 1040 may be configured to have a function of detecting a specific subject such as a person in the high-quality video after having inferred the high-quality video from the low-quality video or may be configured to have a function of performing character recognition in a notice or a sign in the high-quality video. That is, the high-quality video inferred by the learning model 1040 is not limited to an example of a video for appreciation and may be used for detection of an object or the like.

In the related art, all possible scenes are preferably included in training data in order to enhance generalization performance of a training model. In other words, a video including all possible motions of a subject can be said to be ideal training data. On the other hand, it is difficult to acquire such training data through actual imaging, and much cost and time are necessary. By applying the present embodiment to training of a learning model, it is possible to greatly decrease the cost and the time required for collecting training data. By applying the present embodiment to training of a learning model, it is possible to improve generalization performance of the learning model.

While the present invention has been described above in conjunction with embodiments, the present invention is not limited to these embodiments, and various modifications and substitutions can be added thereto without departing from the gist of the present invention.

### Reference Signs List

1 . . . High-quality video generation system, 2 . . . Image processing device, 10 . . . Input information generation device, 11 . . . Image acquiring unit, 12 . . . Input converting unit, 13 . . . Combination unit, 14 . . . Output unit, 15 . . . Integration unit, 16 . . . Average temporary storage unit, 17 . . . Imaging condition acquiring unit, 18 . . . Adjustment unit, 19 . . . Comparison unit, 100 . . . Imaging device, 200 . . . CNN, 210 . . . Input layer, 220 . . .

Convolution layer, 230 . . . Pooling layer, 240 . . . Output layer, IM . . . Video information, IN . . . Input information, TF . . . Target frame, AF . . . Adjacent frame, IF . . . Integrated frame, M1 . . . First memory, M2 . . . Second memory, IMD . . . Image information, IND . . . Input data, CD . . . Combined data, SV . . . Stored value, CV . . . Calculated value, CR . . . Comparison result, 1001 . . . Learning system, 1010 . . . Learning device, 1011 . . . Image acquiring unit, 1012 . . . Video information generating unit, 1013 . . . Learning unit, 1014 . . . Trajectory vector acquiring unit, 1020 . . . Imaging device, 1031 . . . High-quality image, 1032 . . . Low-quality image, 1033 . . . High-quality video, 1034 . . . Low-quality video, 1040 . . . Learning model, 1050 . . . Trajectory vector generation device, TD . . . Training data, I . . . Image information, I1 . . . First image information, I2 . . . Second image information, M . . . Video information, M1 . . . First video information, M2 . . . Second video information, TV . . . Trajectory vector, 1121 . . . Cutout unit, 1123 . . . Noise superimposing unit, 1125 . . . First video information generating unit, 1127 . . . Second video information generating unit

1. An input information generation device comprising:
an image acquiring unit configured to acquire a plurality of frames including at least a target frame of which input information is to be generated out of frames constituting a video as an input image;
an input converting unit configured to convert pixel values of the acquired input image of the plurality of frames to input data with a smaller number of bits than the number of bits indicating the pixel values of the input image;
a combination unit configured to combine the plurality of pieces of converted input data into one piece of combined data; and
an output unit configured to output the combined data.

2. The input information generation device according to claim 1, wherein the video is a color video,
wherein the image acquiring unit acquires pixel values of colors as a plurality of different images from one frame, and
wherein the input converting unit converts the plurality of images acquired from one frame to the input data.

3. The input information generation device according to claim 1, wherein the image acquiring unit acquires images of a plurality of frames which are continuously adjacent to before and after the target frame out of the frames constituting the video.

4. The input information generation device according to claim 1, wherein the image acquiring unit acquires a plurality of frames including at least the target frame with frames adjacent to the target frame as a target frame as the input image after the combined data for the target frame has been output by the output unit.

5. The input information generation device according to claim 1, further comprising an integration unit configured to integrate a plurality of adjacent frames into one integrated frame by performing an arithmetic operation based on pixel values of the adjacent frames which are frames other than the target frame out of the plurality of frames acquired by the image acquiring unit,
wherein the input converting unit converts pixel values of the target frame to the input data and additionally converts pixel values of the integrated frame to the input data, and
wherein the combination unit combines the plurality of pieces of input data converted on the basis of the target frame and the plurality of pieces of input data converted on the basis of the integrated frame into one piece of combined data.

6. The input information generation device according to claim 5, wherein the integration unit sets an average value of the pixel values of the plurality of adjacent frames as pixel values of the integrated frame.

7. The input information generation device according to claim 6, wherein the integration unit calculates the pixel values of the integrated frame by calculating a weighted average based on a temporal distance from the target frame out of the plurality of adjacent frames.

8. The input information generation device according to claim 6, wherein the integration unit excludes a frame with a large change in luminance out of the frames constituting the video from targets of which an average value is to be calculated.

9. The input information generation device according to claim 5, further comprising an average temporary storage unit configured to store an average value of pixel values of predetermined frames out of the frames constituting the video,
wherein the integration unit calculates pixel values of the integrated frame through an arithmetic operation based on the value stored in the average temporary storage unit and the target frame.

10. The input information generation device according to claim 9, further comprising:
an imaging condition acquiring unit configured to acquire imaging conditions of the video; and
an adjustment unit configured to adjust the average value stored in the average temporary storage unit according to the acquired imaging conditions.

11. The input information generation device according to claim 9, further comprising a comparison unit configured to compare the pixel values of the target frame with the value stored in the average temporary storage unit,
wherein the integration unit calculates the pixel values of the integrated frame by calculating a moving average based on the value stored in the average temporary storage unit and the target frame when a difference as a comparison result from the comparison unit is equal to or less than a predetermined value and sets the pixel values of the target frame as the pixel values of the integrated frame when the difference is not equal to or less than the predetermined value.

12. The input information generation device according to claim 5, wherein the integration unit sets a frame which is randomly identified out of the adjacent frames acquired by the image acquiring unit as the integrated frame.

13. An image processing device comprising:
the input information generation device according to claim 1; and
a convolutional neural network configured to receive the combined data output from the input information generation device as input information.

14. An input information generation method comprising:
an image acquiring step of acquiring a plurality of frames including at least a target frame of which input information is to be generated out of frames constituting a video as an input image;
an input converting step of converting pixel values of the acquired input image of the plurality of frames to input data with a smaller number of bits than the number of bits indicating the pixel values of the input image;
a combination step of combining the plurality of pieces of converted input data into one piece of combined data; and
an output step of outputting the combined data.

15. A learning device comprising:
an image acquiring unit configured to acquire first image information including at least one image and second image information having the same subject as a subject captured in the image included in the first image information captured therein and including at least one image with a lower image quality than that of the image included in the first image information;
a video information generating unit configured to cut out a plurality of images at different positions which are a part of the acquired first image information, to combine the plurality of cut-out images to generate first video information, to cut out a plurality of images at different positions which are a part of the acquired second image information, and to combine the plurality of cut-out images to generate second video information; and
a learning unit configured to perform learning to infer a high-quality video from a low-quality video on the basis of training data including the first video information and the second video information generated by the video information generating unit.

16. The learning device according to claim 15, wherein the second image information includes a plurality of images in which the same subject as a subject captured in the image included in the first image information is captured and on which different values of noise are superimposed, and
wherein the video information generating unit generates the second video information by cutting out different parts from the plurality of images included in the second image information.

17. The learning device according to claim 16, wherein the plurality of images included in the second image information are images which are captured at proximately different times.

18. The learning device according to claim 15, wherein the video information generating unit generates the first video information by cutting out different parts from the one image included in the first image information.

19. The learning device according to claim 15, wherein the video information generating unit cuts out a plurality of images at different positions by shifting the plurality of cut-out images in a predetermined direction.

20. The learning device according to claim 15, wherein the video information generating unit cuts out a plurality of images at positions which are shifted by a predetermined number of bits in a predetermined direction.

21. The learning device according to claim 19, wherein the predetermined direction in which an image is cut out by the video information generating unit is calculated by an affine transformation.

22. The learning device according to claim 19, further comprising a trajectory vector acquiring unit configured to acquire a trajectory vector,
wherein the predetermined direction in which an image is cut out by the video information generating unit is calculated on the basis of the acquired trajectory vector.

23. A learning device comprising:
an image acquiring unit configured to acquire image information including at least one image;
a cutout unit configured to cut out a plurality of images at different positions which are a part of the acquired image information;
a first video information generating unit configured to combine the plurality of cut-out images to generate first video information;
a noise superimposing unit configured to superimpose noise on the plurality of images cut out by the cutout unit;
a second video information generating unit configured to combine the plurality of images on which noise is superimposed by the noise superimposing unit to generate second video information; and
a learning unit configured to perform learning to infer a high-quality video from a low-quality video on the basis of training data including the first video information generated by the first video information generating unit and the second video information generated by the second video information generating unit.

24. A program causing a computer to perform:
an image acquiring step of acquiring first image information including at least one image and second image information having the same subject as a subject captured in the image included in the first image information captured therein and including at least one image with a lower image quality than that of the image included in the first image information;
a video information generating step of cutting out a plurality of images at different positions which are a part of the acquired first image information, combining the plurality of cut-out images to generate first video information, cutting out a plurality of images at different positions which are a part of the acquired second image information, and combining the plurality of cut-out images to generate second video information; and
a learning step of performing learning to infer a high-quality video from a low-quality video on the basis of training data including the first video information and the second video information generated in the video information generating step.

25. A learning method for a noise reduction device, the learning method comprising:
an image acquiring process of acquiring first image information including at least one image and second image information having the same subject as a subject captured in the image included in the first image information captured therein and including at least one image with a lower image quality than that of the image included in the first image information;
a video information generating process of cutting out a plurality of images at different positions which are a part of the acquired first image information, combining the plurality of cut-out images to generate first video information, cutting out a plurality of images at different positions which are a part of the acquired second image information, and combining the plurality of cut-out images to generate second video information; and
a learning process of performing learning to infer a high-quality video from a low-quality video on the basis of training data including the first video information and the second video information generated in the video information generating process.
